(19) United States
(12) Patent Application Publication
(10) Pub. No.: US 2002/0097503 A1
(43) Pub. Date: Jul. 25, 2002

(54) ZOOM LENS SYSTEM

(76) Inventors: TETSUO KOHNO, TOYONAKA-SHI (JP); KAZUHIKO ISHIMARU, KAIZUKA-SHI (JP); KENJI KONNO, SAKAI-SHI (JP); MAMORU TERADA, SAKAI-SHI (JP); TETSUYA ARIMOTO, SAKAI-SHI (JP); TAKASHI OKADA, NISHINOMIYA-SHI (JP)

Correspondence Address: SIDLEY AUSTIN BROWN & WOOD LLP, 717 NORTH HARWOOD, SUITE 3400, DALLAS, TX, 75201, US

(21) Appl. No.: 09/162,337

(22) Filed: Sep. 28, 1998

(30) Foreign Application Priority Data
Sep. 30, 1997 (JP) 9-265394
Sep. 30, 1997 (JP) 9-265395
Sep. 30, 1997 (JP) 9-265396
Sep. 30, 1997 (JP) 9-265397
Sep. 30, 1997 (JP) 9-265398

(51) Int. Cl. G02B 15/14

(52) U.S. Cl. 359/690; 359/695

(57) ABSTRACT

A zoom lens system for forming an image of an object on a solid state imaging device includes a first lens unit having a positive optical power and being movable in a zooming operation; a second lens unit having a negative optical power; and a third lens unit having a positive optical power. The system satisfies at least one the following conditions: 0.8<M1WM/M1MT<2.5; 0.2<Δβ3/Δβ2<1.0; 0.7<m1/Z<3.0; 1.0<img*R<15.0; 1.0<max(T1, T2, T3)<4; and 4.5<fT/|f12W|<15, where M1WM represents movement amount of first lens unit from shortest focal length condition to middle focal length condition; M1MT represents movement amount of first lens unit from middle focal length condition to longest focal length condition; Δβ2 represents lateral magnification ratio of second lens unit; Δβ3 represents lateral magnification ratio of third lens unit; m1 represents movement amount of first lens unit in zooming operation; Z represents zoom ratio fT/fW; fW is system focal length at shortest focal length condition; fT represents system focal length at longest focal length condition; img represents maximum image height; R represents effective diameter of lens surface which is closest to image side among lens surfaces constituting zoom lens system; Ti is axial thickness of an i-th unit; max(T1, T2, T3) is maximum thickness; and f12W represents a composite focal length of first and second lens units at shortest focal length condition.

This application is based on Japanese patent application Nos. 9-265394, 9-265395, 9-265396, 9-265397, and 9-265398 filed on Sep. 30, 1997, the entire contents of which are incorporated herein by reference.

### FIELD OF THE INVENTION

The present invention relates to a zoom lens system which is used in a small-sized imaging optical system, and more particularly to a compact zoom lens system of a high variable magnification which is used in an imaging optical system of a digital input/output apparatus, e.g., a digital still camera or a digital video camera.

### DESCRIPTION OF THE RELATED ART

Recently, with the increased use of personal computers, digital cameras (e.g., digital still cameras, digital video cameras, and the like; hereinafter, such a camera is referred to simply as a digital camera), which can easily transfer video information to a digital apparatus, are becoming popular at the private user level. It is expected that in the future such a digital camera is further widespread will be widely employed as an input apparatus for video information.

Usually, the image quality of a digital camera depends on the number of pixels of a solid state imaging device, e.g., a CCD (charge coupled device). At present, most digital cameras for general consumer use employ a solid state imaging device of the so-called VGA class having about 330,000 pixel resolution. However, it is not deniable that the image quality of a camera of the VGA class is largely inferior to that of a conventional camera using a silver halide film. Thus, in the field of digital cameras for general consumer use, a camera of a high image quality and having a pixel resolution of 1,000,000 or higher is desired. Consequently, it is also desirable that the imaging optical system of such a digital camera satisfy a requirement of a high image quality.

Furthermore, it is desirable that these digital cameras for general consumer use perform magnification of an image, particularly optical magnification in which image deterioration is low in magnitude. Therefore, a zoom lens system for a digital camera should satisfy the requirements of a high variable magnification and a high image quality.

However, among zoom lens systems for digital cameras which have been proposed, most of the systems having a pixel resolution of 1,000,000 or higher are those in which an interchangeable lens for a single-lens reflex camera is used as it is or those for a large-sized digital camera for business. Therefore, such zoom lens systems are very large in size and high in production cost, and are not suitable for a digital camera for general consumer use.

By contrast, it may be contemplated that an imaging optical system of a lens shutter camera, which uses a silver halide film and in which compactness and variable magnification have recently noticeably advanced, is used as the imaging optical system of such a digital camera.

However, when an imaging optical system of a lens shutter camera is used as it is in a digital camera, the focal performance of a micro-lens disposed in front of the solid state imaging device of the digital camera cannot be sufficiently satisfied, thereby producing a problem in that the brightness in the center area of an image is largely different from that in the peripheral area of the image. Specifically, this problem is caused by the phenomenon that the exit pupil of an imaging optical system of a lens shutter camera is located in the vicinity of the image plane and hence the off-axis beams emitted from the imaging optical system are obliquely incident on the image plane. When the position of the exit pupil of an imaging optical system of a lens shutter camera of the prior art is separated from the image plane in order to solve the problem, the size of the whole imaging optical system is inevitably increased.

### SUMMARY OF THE INVENTION

It is an object of the invention to solve the above-discussed problem.

It is another object of the invention to provide a zoom lens system which can satisfy the requirements of a high variable magnification and a high image quality.

In order to attain the objects, the zoom lens system comprises, from the object side, a first lens unit having a positive optical power, a second lens unit having negative refractive power, and a third lens unit having a positive refractive power, wherein the zoom lens system fulfills the predetermined conditions.

In the invention, a zoom lens system comprises, from the object side of the zoom lens system to the image side of the zoom lens:

a first lens unit having a positive optical power, the first lens unit being movable in a zooming operation;

a second lens unit having a negative optical power; and

a third lens unit having a positive optical power,

wherein the zooming operation can be performed by varying the distances between adjacent ones of the first, second, and third lens units.

In a first embodiment of the invention, the zoom lens system satisfies at least the following condition:

0.8<M1WM/M1MT<2.5

where

M1WM represents a movement amount of the first lens unit from the shortest focal length condition to a middle focal length condition; and

M1MT represents a movement amount of the first lens unit from the middle focal length condition to the longest focal length condition, the middle focal length being a focal length which is (fW/fT)^{1/2} where fW is a focal length of the entire zoom lens system at the shortest focal length condition and fT is a focal length of the entire zoom lens system at the longest focal length condition.

In another embodiment of the invention, the zoom lens system satisfies at least the following condition:

0.2<Δβ3/Δβ2<1.0

where

Δβ2 represents a ratio of the lateral magnification of the second lens unit at the longest focal length condition to the lateral magnification of the second lens unit at the shortest focal length condition; and

Δβ3 represents a ratio of the lateral magnification of the third lens unit at the longest focal length condition to the lateral magnification of the third lens unit at the shortest focal length condition.

In another embodiment of the invention, the zoom lens system satisfies at least the following condition:

0.7<m1/Z<3.0

where

m1 represents a movement amount of the first lens unit in the zooming operation from the shortest focal length condition to the longest focal length condition; and

Z represents a zoom ratio (Z=fT/fW: where fW is a focal length of the entire zoom lens system at the shortest focal length condition and fT is a focal length of the entire zoom lens unit at the longest focal length condition).

In a further embodiment of the invention, the zoom lens system satisfies at least the following condition:

1.0<img*R<15.0

where

img represents a maximum image height; and

R represents an effective diameter of a lens surface which is closest to the image side among the lens surfaces constituting the zoom lens system. Preferably, the third lens unit can comprise, from the object side to the image side, a positive lens element convex to the object side and a negative lens element.

In another embodiment of the invention, the zoom lens system satisfies at least the following conditions:

1.0<max(T1, T2, T3)<4

4.5<fT/|f12W|<15

where

Ti is the axial thickness of an i-th unit;

max(T1, T2, T3) is the maximum value of the thickness;

fT represents a focal length at the longest focal length condition; and

f12W represents a composite focal length of the first and second lens units at the shortest focal length condition.

In each embodiment, the first and third lens units or all three of the lens units can be movable in the zooming operation so that a first distance between the first and second lens units increases and a second distance between the second and third lens units decreases.

A zoom lens system in accordance with the invention can be employed for forming an image of an object on a solid state imaging device. Filters, including an optical low-pass filter and an infrared blocking filter, can be provided between the lens units and the solid state imaging device.

The invention itself, together with further objects and attendant advantages, will be understood by reference to the following detailed description taken in conjunction with the accompanies drawings.

### BRIEF DESCRIPTION OF THE DRAWINGS

FIG. 1 is a cross sectional view of the lens arrangement of a zoom lens system of Embodiment 1 at the shortest focal length condition;

FIG. 2 is a cross sectional view of the lens arrangement of a zoom lens system of Embodiment 2 at the shortest focal length condition;

FIG. 3 is a cross sectional view of the lens arrangement of a zoom lens system of Embodiment 3 at the shortest focal length condition;

FIG. 4 is a cross sectional view of the lens arrangement of a zoom lens system of Embodiment 4 at the shortest focal length condition;

FIG. 5 is a cross sectional view of the lens arrangement of a zoom lens system of Embodiment 5 at the shortest focal length condition;

FIG. 6 is a cross sectional view of the lens arrangement of a zoom lens system of Embodiment 6 at the shortest focal length condition;

FIG. 7 is a cross sectional view of the lens arrangement of a zoom lens system of Embodiment 7 at the shortest focal length condition;

FIG. 8 is a cross sectional view of the lens arrangement of a zoom lens system of Embodiment 8 at the shortest focal length condition;

FIG. 9 is a cross sectional view of the lens arrangement of a zoom lens system of Embodiment 9 at the shortest focal length condition;

FIGS. 10(a) to 10(i) are aberration diagrams of numerical Embodiment 1;

FIGS. 11(a) to 11(i) are aberration diagrams of numerical Embodiment 2;

FIGS. 12(a) to 12(i) are aberration diagrams of numerical Embodiment 3;

FIGS. 13(a) to 13(i) are aberration diagrams of numerical Embodiment 4;

FIGS. 14(a) to 14(i) are aberration diagrams of numerical Embodiment 5;

FIGS. 15(a) to 15(i) are aberration diagrams of numerical Embodiment 6;

FIGS. 16(a) to 16(i) are aberration diagrams of numerical Embodiment 7;

FIGS. 17(a) to 17(i) are aberration diagrams of numerical Embodiment 8; and

FIGS. 18(a) to 18(i) are aberration diagrams of numerical Embodiment 9.

In the following description, like parts are designed by like reference numbers throughout the several drawings.

### DETAILED DESCRIPTION OF THE PREFERRED EMBODIMENTS

Hereinafter, preferred embodiments of the invention will be described with reference to the accompanying drawings.

In the specification, the term “power” means a quantity which is defined by the reciprocal of a focal length, and includes not only the deflection in the faces of media having refractive indices of different deflection functions, but also the deflection due to diffraction, the deflection due to the distribution of refractive index in a medium, and the like. Furthermore, the term “refractive power” means a quantity which belongs to the above-mentioned “power”, and which is particularly due to a deflection function generated in an interface between media having different refractive indices.

The zoom lens system of Embodiment 1 is configured along the optical axis in the sequence from the object side by: a first lens unit Gr1 comprising a doublet lens element DL1 composed of a negative meniscus lens element L1 having a convex surface on its object side and a bi-convex positive lens L2, and a positive meniscus lens element L3 having a convex surface on its object side; a second lens unit Gr2 comprising a negative meniscus lens element L4 (both faces of which are aspherical surfaces) having a convex surface on its object side, and a doublet lens element DL2 composed of a biconcave negative lens element L5 and a bi-convex positive lens L6; a diaphragm S; a third lens unit Gr3 comprising a positive meniscus lens element L7 having a convex surface on its object side, a negative meniscus lens element L8 (both faces of which are aspherical surfaces) having a convex surface on its object side, a bi-convex positive lens L9, and a bi-convex positive lens element L10 (both faces of which are aspherical surfaces); and a low-pass filter F. In a zooming operation from the shortest focal length condition to the longest focal length condition, the first and third lens units Gr1 and Gr3 are moved toward the object side, the second lens unit Gr2 is moved toward the image side, and the diaphragm S and the low-pass filter F are kept stationary.

The zoom lens system of Embodiment 2 is configured along the optical axis in the sequence from the object side by: a first lens unit Gr1 comprising a negative meniscus lens element Li having a convex surface on its object side, a positive meniscus lens element L2 having a convex surface on its object side, and a positive meniscus lens element L3 having a convex surface on its object side; a second lens unit Gr2 comprising a negative meniscus lens element L4 having a convex surface on its object side, a bi-convex positive lens element L5, and a doublet lens element DL1 composed of a positive meniscus lens element L6 (the front face of which is an aspherical surface) having a convex surface on its image side, and a bi-concave negative lens element L7 (the rear face of which is an aspherical surface); a diaphragm S; a third lens unit Gr3 comprising a bi-convex positive lens element L8 (the front face of which is an aspherical surface), a bi-convex positive lens element L9, a negative meniscus lens element L10 having a convex surface on its object side, a negative meniscus lens element L11 having a convex surface on its image side, and a bi-concave negative lens element L12 (both faces of which are aspherical surfaces); and a low-pass filter F. In a zooming operation from the shortest focal length condition to the longest focal length condition, the first and third lens units Gr1 and Gr3 are moved toward the object side, the second lens unit Gr2 is moved toward the image side, and the diaphragm S and the low-pass filter F are kept stationary.

The zoom lens system of Embodiment 3 is configured along the optical axis in the sequence from the object side by: a first lens unit Gr1 comprising of a negative meniscus lens element L1 having a convex surface on its object side, a positive meniscus lens element L2 having a convex surface on its object side, and a positive meniscus lens element L3 having a convex surface on its object side; a second lens unit Gr2 comprising a negative meniscus lens element L4 having a convex surface on its object side, a bi-convex positive lens element L5, and a doublet lens element DL1 composed of a positive meniscus lens element L6 (the front face of which is an aspherical surface) having a convex surface on its image side and a bi-concave negative lens element L7 (the rear face of which is an aspherical surface); a diaphragm S; a third lens unit Gr3 comprising a bi-convex positive lens element L8 (the front face of which is an aspherical surface), a bi-convex positive lens element L9, a negative meniscus lens element L10 having a convex surface on its object side, and a bi-concave negative lens element L11 (both faces of which are aspherical surfaces); and a low-pass filter F. In a zooming operation from the shortest focal length condition to the longest focal length condition, the first and third lens units Gr1 and Gr3 are moved toward the object side, the second lens unit Gr2 is moved toward the image side, and the diaphragm S and the low-pass filter F are kept stationary.

The zoom lens system of Embodiment 4 is configured along the optical axis in the sequence from the object side by: a first lens unit Gr1 comprising a doublet lens element DL1 composed of a negative meniscus lens element L1 having a convex surface on its object side and a bi-convex positive lens L2, and a positive meniscus lens element L3 having a convex surface on its object side; a second lens unit Gr2 comprising a negative meniscus lens element L4 (both faces of which are aspherical surfaces) having a convex surface on its object side, and a doublet lens element DL2 composed of a bi-concave negative lens element L5 and a bi-convex positive lens L6; a diaphragm S; a third lens unit Gr3 comprising a positive meniscus lens element L7 having a convex surface on its object side, a negative meniscus lens element L8 (both faces of which are aspherical surfaces) having a convex surface on its object side, a bi-convex positive lens L9, and a bi-concave negative lens element L10 (both faces of which are aspherical surfaces); and a low-pass filter F. In a zooming operation from the shortest focal length condition to the longest focal length condition, the first and third lens units Gr1 and Gr3 are moved toward the object side, the second lens unit Gr2 is moved toward the image side, and the diaphragm S and the low-pass filter F are kept stationary.

The zoom lens system of Embodiment 5 is configured along the optical axis in the sequence from the object side by: a first lens unit Gr1 comprising a negative meniscus lens element L1 having a convex surface on its object side, a bi-convex positive lens element L2, and a positive meniscus lens element L3 having a convex surface on its object side; a second lens unit Gr2 comprising a negative meniscus lens element L4 having a convex surface on its object side, a bi-convex positive lens element L5, and a doublet lens element DL1 composed of a positive meniscus lens element L6 (the front face of which is an aspherical surface) having a convex surface on its image side and a bi-concave negative lens element L7 (the rear face of which is an aspherical surface); a diaphragm S; a third lens unit Gr3 comprising a positive meniscus lens element L8 having a convex surface on its object side, a bi-convex positive lens element L9, a bi-concave negative lens element L10, and a positive meniscus lens element L11 (the rear face of which is an aspherical surface) having a convex surface on its object side; and a low-pass filter F. In a zooming operation from the shortest focal length condition to the longest focal length condition, the first and third lens units Gr1 and Gr3 and the diaphragm S are moved toward the object side, the second lens unit Gr2 makes a U-turn in which the lens unit Gr2 is first moved toward the object side and then is moved toward the image side, and the low-pass filter F is kept stationary.

The zoom lens system of Embodiment 6 is configured along the optical axis in the sequence from the object side by: a first lens unit Gr1 comprising a doublet lens element DL1 composed of a negative meniscus lens element L1 having a convex surface on its object side and a bi-convex positive lens element L2, and a positive meniscus lens element L3 having a convex surface on its object side; a second lens unit Gr2 comprising a negative meniscus lens element L4 (the front face of which is an aspherical surface) having a convex surface on its object side, a bi-concave negative lens element L5, a bi-convex positive lens element L6, and a negative meniscus lens element L7 (the rear face of which is an aspherical surface) having a convex surface on its image side; a diaphragm S; a third lens unit Gr3 comprising a bi-convex positive lens element L8 (the front face of which is an aspherical surface), a negative meniscus lens element L9 having a convex surface on its object side, and a positive meniscus lens element L10 (the rear face of which is an aspherical surface) having a convex surface on its object side; and a low-pass filter F. In a zooming operation from the shortest focal length condition to the longest focal length condition, the first and third lens units Gr1 and Gr3 and the diaphragm S are moved toward the object side, the second lens unit Gr2 makes a U-turn in which the lens unit is first moved toward the object side and then is moved toward the image side, and the low-pass filter F is kept stationary.

The zoom lens system of Embodiment 7 is configured along the optical axis in the sequence from the object side by: a first lens unit Gr1 comprising of a doublet lens element DL1 composed of a negative meniscus lens element L1 having a convex surface on its object side and a bi-convex positive lens element L2, and a positive meniscus lens element L3 having a convex surface on its object side; a second lens unit Gr2 comprising a negative meniscus lens element L4 (the front face of which is an aspherical surface) having a convex surface on its object side, and a doublet lens element DL2 composed of a bi-concave negative lens element L5 and a bi-convex positive lens element L6; a diaphragm S; a third lens unit Gr3 comprising a bi-convex positive lens element L7 (the front side of which is an aspherical surface), a negative meniscus lens element L8 having a convex surface on its object side, a doublet lens element DL3 composed of a negative meniscus lens element L9 having a convex surface on its object side and a positive meniscus lens element L10 having a convex surface on its object side, and a positive meniscus lens element L11 (the front side of which is an aspherical surface) having a convex surface on its object side; and a low-pass filter F. In a zooming operation from the shortest focal length condition to the longest focal length condition, the first and third lens units Gr1 and Gr3 and the diaphragm S which is integrated with the third lens unit Gr3 are moved toward the object side, the second lens unit Gr2 is moved toward the image side, and the low-pass filter F is kept stationary.

The zoom lens system of Embodiment 8 is configured along the optical axis in the sequence from the object side by: a first lens unit Gr1 comprising a negative meniscus lens element L1 having a convex surface on its object side, a bi-convex positive lens element L2, and a positive meniscus lens element L3 having a convex surface on its object side; a second lens unit Gr2 comprising a negative meniscus lens element L4 having a convex surface on its object side, a bi-concave negative lens element L5, and a positive meniscus lens element L6 (both faces of which are aspherical surfaces) having a convex surface on its object side; a diaphragm S; a third lens unit Gr3 comprising a positive meniscus lens element L7 having a convex surface on its object side, a bi-convex positive lens element L8, and a negative meniscus lens element L9 (both faces of which are aspherical surfaces) having a convex surface on its object side; and a low-pass filter F. In a zooming operation from the shortest focal length condition to the longest focal length condition, the first and third lens units Gr1 and Gr3 are moved toward the object side, the second lens unit Gr2 is moved toward the image side, the diaphragm S makes a U-turn in which the diaphragm is first moved toward the object side and then is moved toward the image side, and the low-pass filter F is kept stationary.

The zoom lens system of Embodiment 9 is configured in the sequence from the object side by: a first lens unit Gr1 comprising a doublet lens element DL1 composed of a negative meniscus lens element L1 having a convex surface on its object side and a bi-convex positive lens element L2, and a positive meniscus lens element L3 having a convex surface on its object side; a second lens unit Gr2 comprising a negative meniscus lens element L4 (the rear face of which is an aspherical surface) having a convex surface on its object side, a bi-concave negative lens element L5, and a bi-convex positive lens element L6; a diaphragm S; a third lens unit Gr3 comprising a bi-convex positive lens element L7 (the front side of which is an aspherical surface), a negative meniscus lens element L8 having a convex surface on its object side, and a bi-convex positive lens element L9 (the rear side of which is an aspherical surface); and a low-pass filter F. In a zooming operation from the shortest focal length condition to the longest focal length condition, all the components are moved toward the object side.

Hereinafter, conditions which are to be satisfied by the zoom lens systems of the embodiments will be described. It is not required to simultaneously satisfy all of the following conditions.

Preferably, the zoom lens system of the invention satisfy the condition defined by the following range of conditional expression (1):

3.0<f1/fW<9.0 (1)

where

f1 represents a focal length of the first lens unit,

fW represents a focal length of the whole system at the shortest focal length condition.

The above conditional expression (1) defines the focal length of the first lens unit. When the upper limit of range of conditional expression (1) is exceeded, the focal length of the first lens unit increases excessively, so that the movement amount of the first lens unit in a zooming operation from the shortest focal length condition to the longest focal length condition increases. Therefore, the total length of the zoom lens system at the longest focal length condition increases, with the result that a compact zoom lens system cannot be obtained. By contrast, when the lower limit of range of conditional expression (1) is exceeded, the power of the first lens unit increases excessively, so that the aberration generated in the first lens unit, particularly the spherical aberration in the long focal length side, increases. As a result, the zoom lens system as a whole cannot attain an excellent optical performance. Therefore, this is not preferable.

More preferably, with respect to the above condition, the ranges of conditional expressions (1a) to (1c), within the range of conditional expression (1), are satisfied in the following sequence:

3.5<f1/fW<9.0 (1a)

4.5<f1/fW<9.0 (1b)

5.0<f1/fW<9.0 (1c)

wherein f1 and fW are defined supra.

Preferably, the zoom lens systems of the invention satisfy the condition defined by the range of conditional expression(2):

−1.3<f2/fW<−0.7 (2)

where

f2 represents a focal length of the second lens unit, and

fW is as defined supra.

The above conditional expression (2) defines the focal length of the second lens unit. When the value of f2/fW is less than the lower limit of the range of conditional expression (2), the focal length of the second lens unit decreases, so that the axial distance between the second and third lens units at the shortest focal length condition increases. Therefore, the total length at the shortest focal length condition increases. As a result, the diameters of the lenses of the first and second lens units are enlarged. Therefore, this is not preferable. By contrast, when the upper limit of the range of conditional expression (2) is exceeded, the power of the second lens unit increases, so that the aberration generated in the first lens unit, particularly the Petzval sum, increases in the minus direction, thereby causing the Petzval sum of the whole system to be excessively large. As a result, the whole system cannot obtain an excellent optical performance. Therefore, this is not preferable.

More preferably, with respect to the above conditional expression (2), the ranges of conditional expressions (2a) and (2b), within the range of conditional expression (2), are satisfied in the following sequence:

−1.3<f2/fW<−0.8 (2a)

−1.4<f2/fW<−0.8 (2b)

wherein f2 and fW are as defined supra.

Preferably, the zoom lens systems of the invention satisfy the condition defined by the range of the following conditional expression (3):

1.1<f3/fW<1.8 (3)

where

f3 represents a focal length of the third lens unit, and

fW is as defined supra.

The above conditional expression (3) defines the focal length of the third lens unit. When the upper limit of range of conditional expression (3) is exceeded, the focal length of the third lens unit increases excessively. Therefore, the total length at the longest focal length condition becomes too long, with the result that a compact zoom lens system cannot be obtained. By contrast, when the value of f3/fW is less than the lower limit of the range of conditional expression (3), the power of the third lens unit increases, so that the aberration generated in the third lens unit, particularly a coma aberration, increases. The coma aberration cannot be corrected even by forming an aspherical surface at any place in a zoom lens system. As a result, the whole system cannot attain an excellent optical performance. Therefore, this is not preferable.

More preferably, with respect to the above conditional expression (3), the following conditional expression (3a), within the range of conditional expression (3), is satisfied:

1.8<f3/fW<1.9 (3a)

Preferably, the zoom lens systems of the invention satisfy the condition defined by the range of the following conditional expression (4):

1.0<img*R<15.0 (4)

where

img represents a maximum image height (the unit is mm), and

R represents an effective diameter (the unit is mm) of the lens surface which is closest to the image side among the lens surfaces (excluding the filter and the like) constituting the zoom lens system.

The above conditional expression (4) is set in order to balance the conditions on the degree of the zoom lens diameter and the aberration corrections, with those peculiar to an imaging optical system of a digital camera. In an imaging optical system of a digital camera using a solid state imaging device, in order to sufficiently satisfy the focal property of a microlens disposed in front of the solid state imaging device, the light flux must generally be incident with an angle which is substantially perpendicular to the light flux of the microlens. Therefore, it is desirable that an imaging optical system of a digital camera correct aberrations in the same manner as that of a conventional camera using a silver halide film, and also be approximately telecentric with respect to the image side. When the upper limit of the range of conditional expression (4) is exceeded in the zoom lens system, the approximate telecentric state with respect to the image side becomes stronger than required, and aberrations, particularly, a negative distortion aberration in the short focal length side, increase excessively. As a result, the aberrations are hardly corrected and the image plane is largely curved toward the under side. Therefore, this is not preferable. By contrast, when the value of img*R is less than the lower limit of range of conditional expression (4), it is difficult to satisfy the approximate telecentric state, and hence this is not preferable. When the telecentricity is to be improved under the state where the value img*R is less than the lower limit, the back focus of the zoom lens system is larger than required, thereby causing the size of the optical system to be increased. Therefore, this is not preferable.

More preferably, with respect to the above conditional expression (4), the range of the following conditional expression (4a), within the range of the conditional expression (4), is satisfied:

6.5<img*R<9.5 (4a)

In a zoom lens system which is configured along the optical axis in the sequence from the object side by a first lens unit having positive optical power, a second lens unit having negative optical power, and a third lens unit having positive optical power in the same manner as the zoom lens systems of the embodiments, the third lens unit preferably comprises a positive lens component including the positive lens element which is closest to the image side and which has a strong curvature face, and a negative lens component formed by at least one negative lens element. According to this configuration, aberrations can be satisfactorily corrected.

With respect to the positive lens element which is closest to the object side among the lens elements of the third lens unit, the condition defined by the range of the following conditional expression (5) is preferably satisfied:

0.1<Ra/f3<3.0 (5)

where

Ra represents a radius of curvature of the object side-face of the positive lens element which is closest to the object side among the lens elements of the third lens unit, and

f3 represents a focal length of the third lens unit.

The above condition defines a ratio of the radius of curvature, of the object side-face of the positive lens element which is closest to the object side among the lens elements of the third lens unit, to the focal length of the third lens unit, and relates to the aberration correcting power of the positive lens element. When the upper limit of the range of conditional expression (5) is exceeded, the curvature of the positive lens element becomes too weak, and the tendency of a spherical aberration to vary toward the overside is increased. Therefore, this is not preferable. By contrast, when the value of Ra/f3 is less than the lower limit of the range of conditional expression (5), the curvature of the positive lens element becomes too strong, and the tendency of a spherical aberration to vary toward the underside is increased. Therefore, this is not preferable. Moreover, when the value of Ra/f3 is less than the lower limit of the range of conditional expression (5), the radius of curvature of the object side-face of the positive lens element is reduced excessively, and hence it is difficult to produce the positive lens element. Therefore, this is not preferable.

In a zoom lens system which is configured along the optical axis in the sequence from the object side by a first lens unit having positive optical power, a second lens unit having negative optical power, and a third lens unit having positive optical power in the same manner as the zoom lens systems of the embodiments, the second lens unit is preferably configured along the optical axis in the sequence from the object side by: a first sub-unit of the second lens unit, including a lens element in which a concave face of a stronger curvature is directed toward the image side; and a second sub-unit of the second lens unit, including at least one positive lens element on the object side, and one negative lens element. In the case where the second lens unit is configured in this way, when light beams are emitted from the concave face of stronger curvature in the first sub-unit of the second lens unit, the emission angles of the off-axis beams and the axial beams are reduced, particularly in the short focal length side, so that aberration corrections of the second sub-unit of the second lens unit and the subsequent lens unit can be facilitated.

With respect to the concave face in the first sub-unit of the second lens unit, the condition defined by the range of the following conditional expression (6) is preferably satisfied:

−1.6<R2n/f2<−0.6 (6)

where

R2n represents a radius of curvature of the concave face in the first sub-unit of the second lens unit, and

f2 represents a focal length of the second lens unit.

The above conditional expression (6) defines a ratio of the radius of curvature, of the concave face of stronger curvature in the first sub-unit of the second lens unit, to the focal length of the second lens unit, and relates to the aberration correcting power of the concave face. When the value of R2n/f2 is less than the lower limit of range of conditional expression (6), the curvature of the concave face becomes too weak, and the above-mentioned function, i.e., the function of reducing the emission angles of off-axis beams and axial beams when light beams incident on the concave face are emitted from the concave face cannot be sufficiently attained. As a result, when the value of R2n/f2 is less than the lower limit of the range of conditional expression (6), light beams to be emitted from the first sub-unit of the second lens unit are emitted to the subsequent unit while maintaining the large angle between the off-axis beams and the axial beams, and aberrations in the image plane, particularly a curvature of field and a coma aberration, cannot be corrected in the subsequent unit. Therefore, this is not preferable. By contrast, when the upper limit of the range of conditional expression (6) is exceeded, the curvature of the concave face becomes too strong, so that a very large aberration is singly generated in the concave face. The aberration cannot be corrected in another face. Therefore, this is not preferable. Moreover, when the upper limit of the range of conditional expression (6) is exceeded, the radius of curvature of the concave face is reduced excessively, and hence it is difficult to produce such a concave face. Therefore, this is not preferable.

Preferably, the second sub-unit of the second lens unit is configured along the optical axis in the sequence from the object side by: a bi-convex positive single, lens element; and a doublet lens element composed of a positive lens element having a convex face on its image side, and a bi-concave negative lens element. The second lens unit has a negative optical power as a whole. However, in the case where a chromatic aberration is to be corrected in the second lens unit, one positive lens element and at least one negative lens element must be included at least in the second lens unit. On the other hand, since the concave face of stronger curvature on the image side exists in the first sub-unit of the second lens unit as described above, a positive lens element of a high power for correcting the chromatic aberration generated in the concave face cannot be used in the first sub-unit of the second lens unit. In order to correct chromatic aberration of the whole second lens unit, the second sub-unit of the second lens unit is preferably configured along the optical axis by: a bi-convex positive single lens element; and a doublet lens element composed of a positive lens element having a convex face on its image side, and a bi-concave negative lens element.

With respect to the positive lens element of the second sub-unit of the second lens unit, the condition defined by following range of conditional expression (6)′ is satisfied.

−2.5<f2p/f2<−1.0 (6)′

where

f2p represents a focal length of the positive lens element of the second sub-unit of the second lens unit,

f2 represents a focal length of the second lens unit.

The above conditional expression (6)′ defines a ratio of the focal length, of the positive lens element of the second sub-unit of the second lens unit, to the focal length of the second lens unit, and relates to the correction of a chromatic aberration of the second lens unit. When the value f2p/f2 is less than the lower limit of the range of conditional expression (6)′, the power of the positive lens element becomes too weak, and a chromatic aberration, generated in the second lens unit, is increased. Therefore, this is not preferable. By contrast, when the upper limit of the range of conditional expression (6)′ is exceeded, the power of the positive lens element becomes too strong, so that, in order to correct the chromatic aberration of the second lens unit, the power of the negative lens included in the second lens unit must be enhanced. As a result, although the chromatic aberration can be corrected, it is difficult to correct a usual monochromatic aberration. Therefore, this is not preferable.

In the zoom lens systems of the invention, the first lens unit comprises in the sequence along the optical axis from the object side: a negative lens element having a convex face on its image side, a bi-convex positive lens element, and a positive lens element having a convex face on its object side. In order to correct a chromatic aberration in the first lens unit, at least one positive lens element and at least one negative lens element must be disposed in the first lens unit. However, when the first lens unit having a positive optical power as a whole is configured by using only one positive lens element and one negative lens element, it is difficult to correct an aberration in the long focal length side, particularly a spherical aberration. In order to correct a spherical aberration of high order in the long focal length side, the first lens unit, in which the axial beams pass at a high beam height, is preferably provided with a degree of freedom in design (the number of lens elements) for further aberration correction. Moreover, when the first lens unit is configured by using only one positive lens element and one negative lens element, it is difficult to correct a chromatic aberration in the range of optical constants of existing glass and plastics.

In the case where the first lens unit is configured along the optical axis in the sequence from the object side by: a negative lens element having a convex face on its image side, a bi-convex positive lens element, and a positive lens element having a convex face on its object side as described above, the conditions defined by the ranges of the following conditional expressions (7) and (8) are preferably satisfied:

νn<35 (7)

νp>50 (8)

where

νn represents an Abbe number of the negative lens element of the first lens unit, and

νp represents an Abbe number of each positive lens element of the first lens unit.

The above conditional expressions (7) and (8) relate to the correction of a chromatic aberration in the first lens unit. When the Abbe numbers of the one negative lens element and the two positive lens elements of the first lens unit are adequately defined, a chromatic aberration in the first lens unit can be satisfactorily corrected.

With respect to the conditional expression (7), when the following ranges of conditional expression are further satisfied, a chromatic aberration can be more satisfactorily corrected.

νn<32 (7a)

νn<30 (7b)

The zoom lens system of each of the embodiments is configured so that, in a zooming operation from the shortest focal length condition to the longest focal length condition, the first lens unit is moved toward the object side. According to this configuration, the total length of the zoom lens system at the shortest focal length condition can be made short, and the diameters of the lens elements constituting the first lens unit can be reduced. Therefore, this configuration is preferable.

When, in a zooming operation from the shortest focal length condition to the longest focal length condition, the first lens unit is to be moved toward the object side as described above, the condition defined by the range of the following conditional expression (9) is preferably satisfied:

0.7<m1/Z<3.0 (9)

where

m1 represents a movement amount (mm) of the first lens unit in the zooming operation from the shortest focal length condition to the longest focal length condition, and

Z represents a zoom ratio (Z=fT/fW: ratio of the focal length at the shortest focal length condition to that of the longest focal length condition).

The above conditional expression (9) shows the relationship between the movement amount of the first lens unit, in the zooming operation from the shortest focal length condition to the longest focal length condition, and the zoom ratio. Usually, as the zoom ratio is higher, the movement amount is larger. Conditional expression (9) defines the condition for adequately defining the movement amount of the first lens unit, so that a zoom lens which is compact and which has an excellent optical performance is provided. When the upper limit of the conditional expression (9) is exceeded, the movement amount of the first lens unit becomes too large as compared with the zoom ratio. Therefore, the total length of the zoom lens system at the longest focal length condition increases excessively, with the result that a compact zoom lens system cannot be obtained. By contrast, when the value m1/Z is less than the lower limit of the range of conditional expression (9), the movement amount of the first lens unit becomes too small. When the movement amount of the first lens unit is small, the zoom ratio cannot be attained unless the power of the first lens unit is made larger. As a result, the power of the first lens unit increases excessively, so that the degree of an aberration generated in the first lens unit increases. As a result, the zoom lens system as a whole cannot attain excellent optical performance.

More preferably, with respect to the above condition (9), more preferably, the condition defined by the range of the following conditional expression (9a), within the range of conditional expression (9), is satisfied.

0.8<m1/Z<3.0 (9a)

When, in a zooming operation from the shortest focal length condition to the longest focal length condition, the first lens unit is to be moved toward the object side as described above, the condition defined by the range of the following conditional expression (10) is preferably satisfied.

0.8<M1WM/M1MT<2.5 (10)

where

M1WM represents a movement amount of the first lens unit from the shortest focal length condition to the middle focal length condition, and

M1MT represents a movement amount of the first lens unit from the middle focal length condition to the longest focal length condition, the middle focal length being a focal length which is (fW*fT )^{1/2} where fW is the focal length of the entire zoom lens system at the shortest focal length condition and fT is the focal length of the entire zoom lens system at the longest focal length condition.

The above conditional expression (10) defines a ratio of the movement amount of the first lens unit, from the shortest focal length condition to the middle focal length condition, to that from the middle focal length condition to the longest focal length condition, and shows that the variation of the movement amount of the first lens unit in the change from the shortest focal length condition to the middle focal length condition is larger than that in the change from the middle focal length condition to the longest focal length condition. In particular, when the movement amount of the first lens unit from the shortest focal length condition to the middle focal length condition is set to be relatively large, the position of the entrance pupil in the range of the middle focal length can be made remote from the image plane, and the flare component of off-axis beams can be moved away.

More preferably, with respect to the above condition, the condition defined by the ranges of the following conditional expressions (10a) and (10b), within the range of conditional expression (10), are satisfied:

0.9<M1WM/M1MT<2.5 (10a)

1.2<M1WM/M1MT<2.2 (10b)

Preferably, the zoom lens systems of the embodiments satisfy the condition defined by the range of the following conditional expression (11):

1<max(T1, T2, T3)/fW<4 (11)

where

Ti is the axial thickness of an i-th unit and max(T1, T2, T3)is the maximum value of the thickness.

The above conditional expression (11) is set in order to attain a zoom lens system which is small in size and which has a high magnification. When the value of max(T1, T2, T3)/fW is less than the lower limit of the range of conditional expression (11), the axial thicknesses of the lens units become too small, and it is difficult to ensure working requirements (the center thickness, the edge thickness, and the like) of the lens elements constituting the lens units. Furthermore, the degree of freedom in design required for the correction of an aberration cannot be ensured. By contrast, when the upper limit of range of conditional expression (11) is exceeded, the axial thicknesses of the lens units become too large, and a compact zoom lens system cannot be attained.

More preferably, with respect to the above condition, the condition defined by the range of the following conditional expression (11a), within the range of conditional expression (11), is satisfied:

1<max(T1, T2, T3)/fW<3 (11a)

Preferably, the zoom lens systems of the embodiments satisfy the condition defined by the range of the following conditional expression (12):

6<Lw/fW<10 (12)

where

Lw represents the total length of the optical system at the shortest focal length condition (the length from the tip end of the lens element to the image plane), and fW is as defined supra.

The above conditional expression (12) indicates the telephoto ratio at the shortest focal length condition. When the value of Lw/fW is less than the lower limit of the range of conditional expression (12), the total length of the optical system becomes too short, and it is difficult to correct an aberration. Furthermore, it is difficult to satisfy the approximate telecentric condition required for an imaging optical system of a digital camera. By contrast, when the upper limit of the range of conditional expression (12) is exceeded, the compaction of the zoom lens system cannot be attained. When the total length is increased, the illumination in the image plane cannot be ensured, thereby requiring the diameter of the front lens to be increased. Also in this case, therefore, a compact zoom lens system cannot be attained.

In a zoom lens system, the focal length is varied by changing the distances between lens units, or, in other words, the variable magnification amount (β) of each unit. Therefore, a lens unit in which the variable magnification amount is largely changed as a result of a zooming operation contributes to magnification at a higher degree, and hence inevitably bears a large portion of an aberration. In view of this, in order to efficiently perform a zooming operation, units of a zoom lens system preferably bear variable magnification in a manner as uniform as possible. Realization of such a relationship of the burdens of variable magnification results in the lens units also bearing an aberration in a uniform manner. In this case, it is seemed that the configuration (the number and size of components) of each lens unit of the zoom lens system is optimized.

In view of the above, preferably, the zoom lens systems of the invention satisfy the condition defined by the range of the following conditional expression (13):

0.2<Δβ3/Δβ2<1.0 (13)

where

Δβ2 represents the ratio of lateral magnifications (the lateral magnification at the longest focal length condition/the lateral magnification at the shortest focal length condition) of the second lens unit, and

Δβ3 represents the ratio of lateral magnifications (the lateral magnification at the longest focal length condition/the lateral magnification at the shortest focal length condition) of the third lens unit.

The above conditional expression (13) indicates the burdens of variable magnification of the second and third lens units. Unlike a zoom lens system which is known in the prior art and in which the second lens unit bears a large portion of the variable magnification, the third lens unit also bears variable magnification, thereby allowing a zooming operation to be efficiently performed. As a result, the optical system is shortened, and the lens units are simplified in configuration. When the value Δβ3/Δβ2 is less than the lower limit of the range of conditional expression (13), the burden of variable magnification of the third lens unit decreases and that of the second lens unit increases, and hence spherical aberration in the long focal length side inclines to the underside and also a distortion aberration in the short focal length side increases, with the result that the aberration correction cannot be performed. By contrast, when the upper limit of range of conditional expression (13) is exceeded, the burden of variable magnification of the third lens unit increases. Therefore, a spherical aberration in the long focal length side varies to the overside, an off-axis coma aberration is generated in both the long and short focal length sides, and the aberration correction cannot be performed by the other components. In both cases, when the configuration is used as it is, the aberration correction cannot be sufficiently performed, and an increase of the degree of freedom in design inevitably causes the number of components to be increased and the size of the lens system to be enlarged.

More preferably, with respect to the above conditional expression (13), the condition defined by the ranges of the following conditional expressions (13a) to (13c) within the range of conditional expression (13) are satisfied:

0.25<Δβ3/Δβ2<1.0 (13a)

0.5<Δβ3/Δβ2<1.0 (13b)

0.7<Δβ3/Δβ2<1.0 (13c)

Preferably, the zoom lens systems of the invention satisfy the condition defined by the range of the following conditional expression (14):

3.5<βT2/βw2<6.5 (14)

where

βT2 represents a lateral magnification of the second lens unit at the longest focal length condition, and

βw2 represents a lateral magnification of the second lens unit at the shortest focal length condition.

The above conditional expression (14) defines the change of the lateral magnification of the second lens unit in variable magnification, and more specifically defines the burden of variable magnification of the second lens unit. When the upper limit of the range of conditional expression (14) is exceeded, the burden of the variable magnification of the second lens unit becomes too large, and hence a spherical aberration in the long focal length side inclines to the underside, and also a distortion aberration in the short focal length side increases, with the result that the aberration correction cannot be performed. By contrast, when the value βT2/βw2 is less than the lower limit of the range of conditional expression (14), the burden of variable magnification of the second lens unit decreases, and the burdens of the other lens units increase. Therefore, a spherical aberration in the long focal length side varies to the overside, and an off-axis coma aberration increases in both the long and short focal length sides. Consequently, this is not preferable.

Preferably, the zoom lens systems of the invention satisfy the condition defined by the range of the following conditional expression (15):

4.5<fT/|f12W|<15 (15)

where

fT represents a focal length at the longest focal length condition, and

f12W represents a composite focal length of the first and second lens units at the shortest focal length condition.

The above conditional expression (15) defines the composite focal length of the first and second lens units at the longest focal length condition, and is set in order to obtain a small-sized lens system of a high magnification. When the value of fT/|f12W| is less than the lower limit of the range of conditional expression (15), the composite focal length of the first and second lens units in the short focal length side becomes too large, and it is difficult to ensure the back focus. Furthermore, the power of the first lens unit or the second lens unit becomes too weak, and a compact zoom lens system cannot be attained. By contrast, when the upper limit of range of conditional expression (15) is exceeded, the composite focal length of the first and second lens units in the short focal length side becomes too small, and it is difficult to correct a distortion aberration in the short focal length side. Furthermore, the power of the first lens unit or the second lens unit becomes too strong, and hence it is difficult to correct an aberration. Therefore, this is not preferable.

In the zoom lens systems of the invention, the second lens unit preferably has at least one aspherical surface which satisfies the condition defined by the range of the following conditional expression (1):

−0.1<ø*(N′−N)*d/dH{X(H)−X0(H)}<0 (16)

where

ø represents a power of a lens element having an aspherical surface,

N represents a refractive index of a medium which is on the object side with respect to the aspherical surface, to the d line,

N′ represents a refractive index of a medium which is on the image side with respect to the aspherical surface, to the d line,

H represents a height in a direction perpendicular to the optical axis,

X(H) represents a displacement amount at the height H of the aspherical surface along the optical axis, and

X0(H) represents a displacement amount at the height H of a reference spherical surface along the optical axis.

Among aspherical surfaces in the second lens unit, an aspherical surface which is disposed so as to be relatively closer to the object is effective in the correction of a distortion aberration in the short focal length side, and that which is disposed so as to be relatively closer to the image is effective in the correction of a spherical aberration in the long focal length side. The aspherical surfaces are set so as to function in a direction along which the power of the paraxial becomes weak, and the configuration consisting of only the aspherical surfaces serves to weaken an aberration which has been excessively corrected. In the embodiments, when the power of an aspherical surface of a negative face disposed in a lens element which is in the second lens unit and closer to the object is too strong, a negative distortion aberration in the short focal length side becomes too large. By contrast, when the negative power becomes weak, the correction of a distortion aberration in the short focal length side is advantageously performed, but an aspherical aberration in the long focal length side is insufficiently corrected, with the result that the optical performance cannot be ensured. Also when a positive power face in the second lens unit has an aspherical surface, similar phenomena occur in both the cases where the power of a positive face in the second lens unit becomes weak, and where the negative optical power becomes strong. When the power of an aspherical surface disposed in a positive face of a lens which is in the second lens unit and relatively closer to the image becomes too weak, a spherical aberration in the long focal length side varies to the overside, and the correction of a spherical aberration is excessively performed. By contrast, when the power becomes too strong, the correction is insufficient. Therefore, both cases are not preferable.

In the zoom lens systems of the invention, the third lens unit preferably has at least one aspherical surface which satisfies the condition defined by the range of the following conditional expression (17):

−0.1<ø*(N′−N)*d/dH{X(H)−X0(H)}<0 (17)

where

ø represents a power of a lens element having an aspherical surface,

N represents a refractive index of a medium which is on the object side with respect to the aspherical surface, to the d line,

N′ represents a refractive index of a medium which is on the image side with respect to the aspherical surface, to the d line,

H represents a height in a direction perpendicular to the optical axis,

X(H) represents a displacement amount at the height H of the aspherical surface along the optical axis, and

X0(H) represents a displacement amount at the height H of a reference spherical surface along the optical axis.

Among aspherical surfaces in the third lens unit, an aspherical surface which is disposed so as to be relatively closer to the object is effective in the correction of a spherical aberration in the short focal length side, and a lens surface which is disposed so as to be relatively closer to the image plane is effective in the correction of the image plane performance and flare in the long focal length side. In the third lens unit, when an aspherical surface is disposed in a direction along which the positive optical power of a lens element closer to the object is weakened, in the case where the power becomes too weak, a spherical aberration in the short focal length side is insufficiently corrected, and, in the case where the power becomes too strong, a spherical aberration is excessively corrected. In both cases, when no countermeasure is taken, it is difficult to correct an aberration in the subsequent optical system. As a result, aberration correction inevitably causes the number of components to be increased, or the size of the lens system to be enlarged. With respect to an aspherical surface disposed in a lens element in the third lens unit closer to the image plane and in a direction along which the negative optical power is weakened, when the negative optical power becomes too weak, the convergency of the upper side for off-axis beams in the long focal length side is impaired and excessive flare is produced, with the result that the image plane performance is lowered. In the short focal length side, the off-axis beams are extremely affected, and an excessive negative distortion aberration is generated. By contrast, when the negative optical power becomes too strong, the off-axis beams in the short focal length side are affected, and the image plane performance in the short focal length side is lowered. Specifically, the off-axis image plane in the short focal length side is curved toward the positive direction and also an aberration cannot be sufficiently corrected in the other faces.

In the invention, the diaphragm is preferably kept stationary in a zooming operation. When the diaphragm is to be moved, a space must be ensured for a cam device for moving the diaphragm, a lens barrel, a cam driving device, and the like, so that the size of an optical apparatus into which the zoom lens system is incorporated is enlarged.

In the embodiments, the diaphragm is preferably disposed between the second and third lens units. The disposition of the diaphragm between the second and third lens units can prevent the quantity of peripheral light from being lowered in a zooming operation from the shortest focal length condition to the middle focal length condition.

Preferably, the full aperture is constant in a zooming operation. Usually, the diaphragm functions by means of an operation of opening or closing diaphragm vanes with respect to a circular opening corresponding to the full FNO. In view of an influence on the image, the opening of the full aperture is preferably circular. In view of an influence on the image, when the full aperture at each focal length condition varies in a zooming operation, the diaphragm must be controlled in accordance with the configuration in which the circular opening is formed by diaphragm vanes or in which plural circular openings are disposed. In the former configuration using diaphragm vanes, when the number of the diaphragm vanes is small, the opening has a distorted shape. In order to make the opening close to be circular, a large number of, for example, five or six vanes are required, whereby the production cost is inevitably increased. In the latter configuration using plural circular openings, the production cost is increased, and a space for inserting the circular openings along the optical axis is necessary, with the result that the size of the optical system is enlarged.

Hereinafter, specific examples of the embodiments will be described with reference to construction data, aberration diagrams, etc.

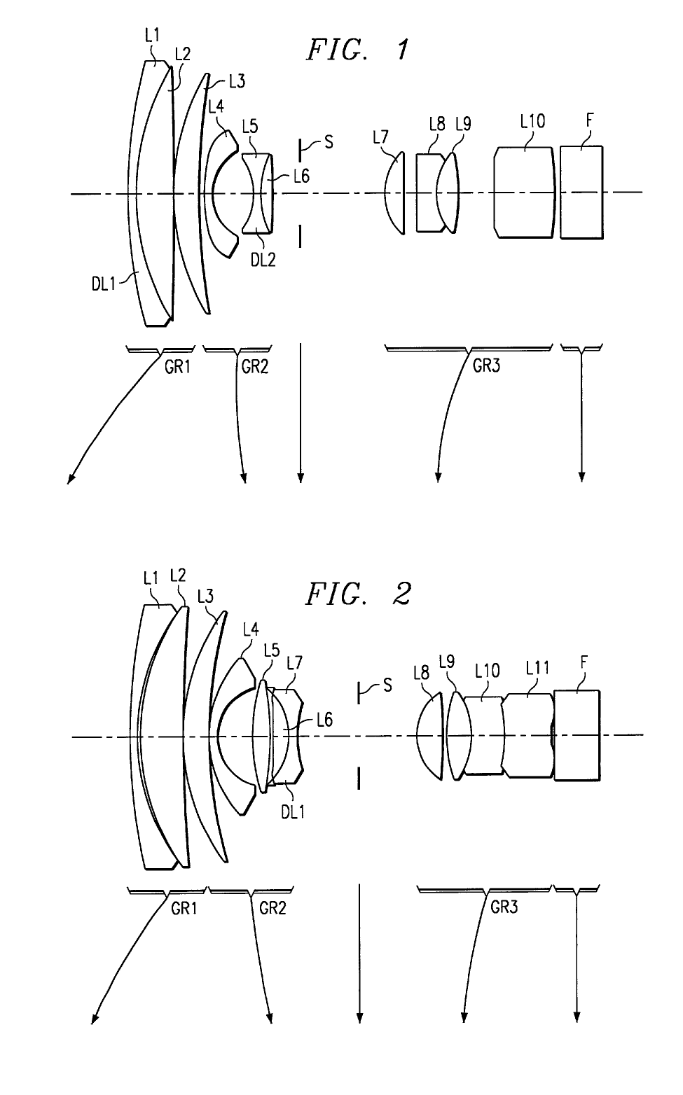

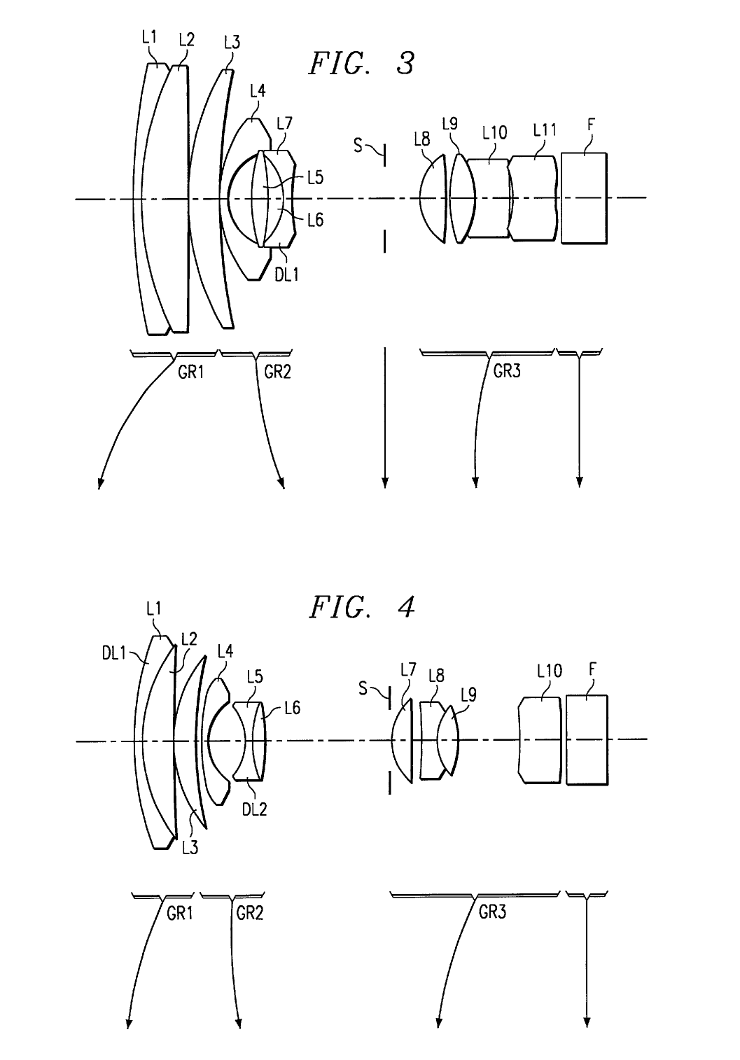

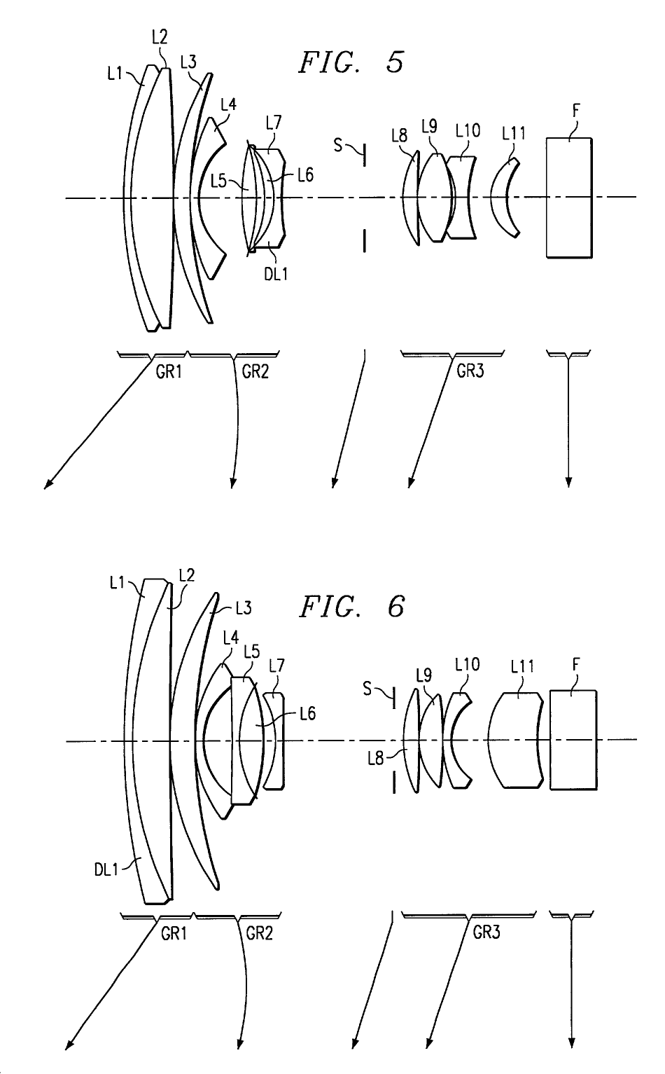

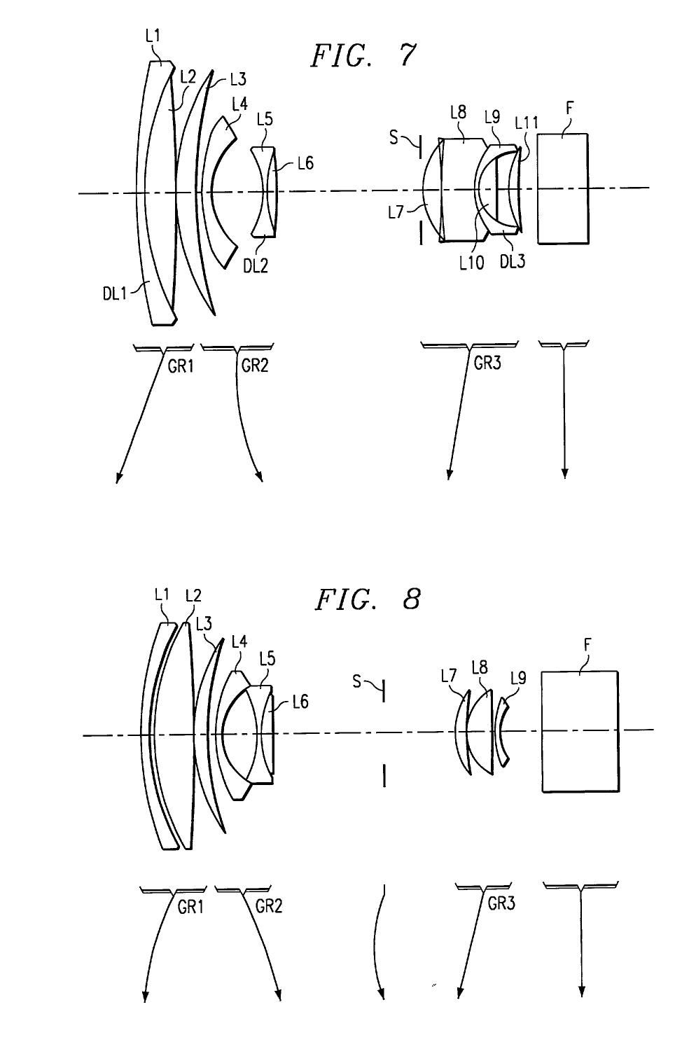

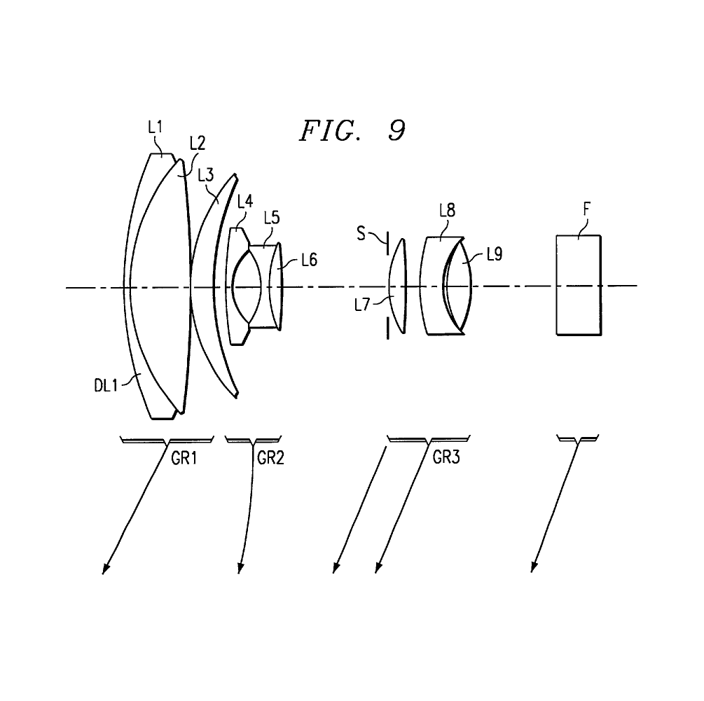

Embodiments 1 to 9, which will be described, correspond to the embodiments described above, with respect to FIGS. 1-9, respectively. The lens arrangement diagrams showing the embodiments indicate the lens configurations of the corresponding Embodiments 1 to 9, respectively.

In the embodiments, ri (i=1, 2, 3 . . . indicates the radius of curvature of an i-th surface counted from the object side, di (i=1, 2, 3 . . . indicates an i-th axial surface separation counted from the object side, and Ni (i=1, 2, 3 . . . ) and vi (i=1, 2, 3 . . . ) indicate the refractive index and the Abbe number of an i-th lens element counted from the object side, to the d line. Furthermore, f indicates the focal length of the whole system, and FNO indicates the F number. The letter E attached to the data of the embodiments indicates the exponential part of the corresponding value. For example, 1.0E-2 indicates 1.0*10⁻². In the first and second embodiments, the focal length f of the whole system, the F number FNO, and the air space (axial surface separation) between the lens units correspond, in the sequence from the left side, to the values at the shortest focal length end (wide angle end) (W), the middle focal length (M), and the longest focal length end (telephoto end) (T), respectively.

In the embodiments, a surface in which the radius of curvature ri is marked with “*” indicates a refractive optical surface having an aspherical shape, or a surface having a refractive action which is equivalent to an aspherical surface, and is defined by the following expression showing the shape of an aspherical surface.

X(H)=CH²/{1−√(1−ε*C²*H²)}+ΣAi*Hi(AS)

where

H represents a height in direction perpendicular to the optical axis,

X(H) represents a displacement amount at the height H along the optical axis (with respect to the surface vertex),

C represents a paraxial curvature,

ε represents a quadric surface parameter,

Ai represents a i-th order aspherical coefficient, and

Hi represents a symbol indicating an i-th power of H.

TABLE 1
[Embodiment 1]

| | |
|---|---|
| f = | 5.10˜16.00˜48.70 |
| FNO = | 2.87˜3.81˜4.10 |

| | | | |
|---|---|---|---|
| Radius of | Axial | Refractive | Abbe |
| Curvature | Distance | Index | Number |

| r1 = | 45.859 | | | | | | |
|---|---|---|---|---|---|---|---|
| | | d1 = | 0.60 | N1 = | 1.848500 | ν1 = | 30.68 |
| r2 = | 20.428 | | | | | | |
| | | d2 = | 2.99 | N2 = | 1.487490 | ν2 = | 70.44 |
| r3 = | −324.147 | | | | | | |
| | | d3 = | 0.10 | | | | |
| r4 = | 19.254 | | | | | | |
| | | d4 = | 2.07 | N3 = | 1.697209 | ν3 = | 53.73 |
| r5 = | 60.367 | | | | | | |
| | | d5 = | 0.50˜12.25˜22.37 | | | | |
| r6* = | 20.403 | | | | | | |
| | | d6 = | 0.60 | N4 = | 1.487490 | ν4 = | 70.44 |
| r7* = | 4.402 | | | | | | |
| | | d7 = | 3.41 | | | | |
| r8 = | −4.856 | | | | | | |
| | | d8 = | 0.60 | N5 = | 1.677393 | ν5 = | 54.61 |
| r9 = | 8.996 | | | | | | |
| | | d9 = | 0.94 | N6 = | 1.847540 | ν6 = | 26.68 |
| r10 = | −35.025 | | | | | | |
| | | d10 = | 9.11˜3.73˜0.50 | | | | |
| r11 = | ∞ | | | | | | |
| | | d11 = | 0.10 | | | | |
| r12 = | 4.931 | | | | | | |
| | | d12 = | 1.52 | N7 = | 1.688805 | ν7 = | 54.09 |
| r13 = | 276.773 | | | | | | |
| | | d13 = | 1.20 | | | | |
| r14* = | 54.486 | | | | | | |
| | | d14 = | 1.55 | N8 = | 1.846943 | ν8 = | 24.67 |
| r15* = | 5.110 | | | | | | |
| | | d15 = | 0.12 | | | | |
| r16 = | 5.287 | | | | | | |
| | | d16 = | 1.71 | N9 = | 1.517549 | ν9 = | 53.54 |
| r17 = | −15.384 | | | | | | |
| | | d17 = | 3.03 | | | | |
| r18* = | 47.080 | | | | | | |
| | | d18 = | 4.94 | N10 = | 1.549950 | ν10 = | 43.56 |
| r19* = | −88.189 | | | | | | |
| | | d19 = | 0.50˜5.65˜7.24 | | | | |
| r20 = | ∞ | | | | | | |
| | | d20 = | 4.00 | N11 = | 1.516800 | ν11 = | 64.20 |
| r21 = | ∞ | | | | | | |

[Aspherical Coefficient]
r6

| | |
|---|---|
| ε = | 1.0000 |
| A4 = | 7.13888 * 10⁻⁴ |
| A6 = | 3.37921 * 10⁻⁶ |
| A8 = | 1.72001 * 10⁻⁶ |
| A10 = | −1.22479 * 10⁻⁷ |
| A12 = | 3.86499 * 10⁻⁹ |

r7

| | |
|---|---|
| ε = | 1.0000 |
| A4 = | 1.67098 * 10⁻⁴ |
| A6 = | −1.15883 * 10⁻⁵ |
| A8 = | 2.22223 * 10⁻⁵ |
| A10 = | −3.12740 * 10⁻⁶ |
| A12 = | 1.79225 * 10⁻⁷ |

r14

| | |
|---|---|
| ε = | 1.0000 |
| A4 = | −1.69606 * 10⁻³ |
| A6 = | 2.67616 * 10⁻⁵ |
| A8 = | −2.23107 * 10⁻⁶ |
| A10 = | 3.32446 * 10⁻⁸ |
| A12 = | 2.70875 * 10⁻⁹ |

r15

| | |
|---|---|
| ε = | 1.0000 |
| A4 = | 2.90840 * 10⁻⁴ |
| A6 = | 5.95412 * 10⁻⁵ |
| A8 = | 1.21372 * 10⁻⁵ |
| A10 = | −4.45671 * 10⁻⁷ |
| A12 = | −1.32895 * 10⁻¹⁶ |

r18

| | |
|---|---|
| ε = | 1.0000 |
| A4 = | −4.29878 * 10⁻⁴ |
| A6 = | −5.56594 * 10⁻⁶ |
| A8 = | 1.05178 * 10⁻⁶ |
| A10 = | 4.77499 * 10⁻⁸ |
| A12 = | −7.26795 * 10⁻⁹ |

r19

| | |
|---|---|
| ε = | 1.0000 |
| A4 = | −6.14789 * 10⁻⁴ |
| A6 = | 1.30569 * 10⁻⁶ |
| A8 = | −1.21935 * 10⁻⁷ |
| A10 = | −1.72881 * 10⁻⁸ |
| A12 = | −3.48285 * 10⁻¹¹ |

TABLE 2
[Embodiment 2]

| | |
|---|---|
| f = | 5.13˜15.50˜48.75 |
| FNO = | 2.73˜4.31˜4.10 |

| | | | |
|---|---|---|---|
| Radius of | Axial | Refractive | Abbe |
| Curvature | Distance | Index | Number |

| r1 = | 54.715 | | | | | | |
|---|---|---|---|---|---|---|---|
| | | d1 = | 0.60 | N1 = | 1.848322 | ν1 = | 29.85 |
| r2 = | 18.426 | | | | | | |
| | | d2 = | 0.30 | | | | |
| r3 = | 19.039 | | | | | | |
| | | d3 = | 3.49 | N2 = | 1.723013 | ν2 = | 52.69 |
| r4 = | 212.770 | | | | | | |
| | | d4 = | 0.10 | | | | |
| r5 = | 18.135 | | | | | | |
| | | d5 = | 2.04 | N3 = | 1.705118 | ν3 = | 53.40 |
| r6 = | 39.130 | | | | | | |
| | | d6 = | 0.10˜11.45˜21.02 | | | | |
| r7 = | 10.006 | | | | | | |
| | | d7 = | 0.64 | N4 = | 1.599814 | ν4 = | 47.31 |
| r8 = | 4.127 | | | | | | |
| | | d8 = | 2.89 | | | | |
| r9 = | 17.521 | | | | | | |
| | | d9 = | 1.53 | N5 = | 1.798500 | ν5 = | 22.60 |
| r10 = | −17.604 | | | | | | |
| | | d10 = | 0.24 | | | | |
| r11* = | −47.805 | | | | | | |
| | | d11 = | 1.34 | N6 = | 1.690894 | ν6 = | 27.09 |
| r12 = | −5.201 | | | | | | |
| | | d12 = | 0.60 | N7 = | 1.849789 | ν7 = | 38.39 |
| r13* = | 6.890 | | | | | | |
| | | d13 = | 7.01˜2.76˜0.38 | | | | |
| r14 = | ∞ | | | | | | |
| | | d14 = | 3.00˜2.00˜0.10 | | | | |
| r15* = | 3.838 | | | | | | |
| | | d15 = | 2.26 | N8 = | 1.487490 | ν8 = | 70.44 |
| r16 = | −38.408 | | | | | | |
| | | d16 = | 0.25 | | | | |
| r17 = | 10.795 | | | | | | |
| | | d17 = | 1.97 | N9 = | 1.487490 | ν9 = | 70.44 |
| r18 = | −7.048 | | | | | | |
| | | d18 = | 0.14 | | | | |
| r19 = | −6.196 | | | | | | |
| | | d19 = | 2.72 | N10 = | 1.846738 | ν10 = | 24.05 |
| r20* = | −21.321 | | | | | | |
| | | d20 = | 0.11 | | | | |
| r21 = | −121.777 | | | | | | |
| | | d21 = | 3.77 | N11 = | 1.524957 | ν11 = | 61.87 |
| r22* = | 14.361 | | | | | | |
| | | d22 = | 0.20˜3.32˜4.91 | | | | |
| r23 = | ∞ | | | | | | |
| | | d23 = | 3.70 | N12 = | 1.516800 | ν12 = | 64.20 |
| r24 = | ∞ | | | | | | |

[Aspherical Coefficient]
r11

| | |
|---|---|
| ε = | 1.0000 |
| A4 = | −1.61599 * 10⁻³ |
| A6 = | 5.40149 * 10⁻⁵ |
| A8 = | 1.17127 * 10⁻⁵ |
| A10 = | −1.31580 * 10⁻⁶ |
| A12 = | 5.77527 * 10⁻⁸ |

r13

| | |
|---|---|
| ε = | 1.0000 |
| A4 = | −3.25983 * 10⁻³ |
| A6 = | 4.40857 * 10⁻⁵ |
| A8 = | 2.32214 * 10⁻⁵ |
| A10 = | −3.63786 * 10⁻⁶ |
| A12 = | 2.01949 * 10⁻⁷ |

r15

| | |
|---|---|
| ε = | 1.0000 |
| A4 = | −1.12778 * 10⁻³ |
| A6 = | −9.41601 * 10⁻⁵ |
| A8 = | 4.09453 * 10⁻⁶ |
| A10 = | −2.40382 * 10⁻⁷ |
| A12 = | −3.39204 * 10⁻⁸ |

r21

| | |
|---|---|
| ε = | 1.0000 |
| A4 = | −7.26725 * 10⁻³ |
| A6 = | −1.50172 * 10⁻⁴ |
| A8 = | −9.25368 * 10⁻⁵ |
| A10 = | 9.06913 * 10⁻⁶ |
| A12 = | −1.04625 * 10⁻⁶ |

r22

| | |
|---|---|
| ε = | 1.0000 |
| A4 = | −4.56040 * 10⁻³ |
| A6 = | −1.54116 * 10⁻⁴ |
| A8 = | 6.72475 * 10⁻⁵ |
| A10 = | −1.14564 * 10⁻⁵ |
| A12 = | 7.09769 * 10⁻⁷ |

TABLE 3
[Embodiment 3]

| | |
|---|---|
| f = | 5.13˜15.50˜48.75 |
| FNO = | 2.73˜4.31˜4.10 |

| | | | |
|---|---|---|---|
| Radius of | Axial | Refractive | Abbe |
| Curvature | Distance | Index | Number |

| r1 = | 56.851 | | | | | | |
|---|---|---|---|---|---|---|---|
| | | d1 = | 0.60 | N1 = | 1.839592 | ν1 = | 27.49 |
| r2 = | 23.446 | | | | | | |
| | | d2 = | 0.11 | | | | |
| r3 = | 23.446 | | | | | | |
| | | d3 = | 3.85 | N2 = | 1.567298 | ν2 = | 61.49 |
| r4 = | −317.865 | | | | | | |
| | | d4 = | 0.10 | | | | |
| r5 = | 21.360 | | | | | | |
| | | d5 = | 2.74 | N3 = | 1.754500 | ν3 = | 51.57 |
| r6 = | 50.308 | | | | | | |
| | | d6 = | 0.10˜13.11˜23.02 | | | | |
| r7 = | 10.549 | | | | | | |
| | | d7 = | 0.60 | N4 = | 1.622384 | ν4 = | 38.80 |
| r8 = | 4.002 | | | | | | |
| | | d8 = | 2.00 | | | | |
| r9 = | 14.422 | | | | | | |
| | | d9 = | 1.35 | N5 = | 1.798500 | ν5 = | 22.60 |
| r10 = | −15.568 | | | | | | |
| | | d10 = | 0.10 | | | | |
| r11* = | −22.319 | | | | | | |
| | | d11 = | 1.35 | N6 = | 1.681782 | ν6 = | 27.64 |
| r12 = | −4.598 | | | | | | |
| | | d12 = | 0.60 | N7 = | 1.850000 | ν7 = | 40.04 |
| r13* = | 7.695 | | | | | | |
| | | d13 = | 7.73˜5.61˜1.19 | | | | |
| r14 = | ∞ | | | | | | |
| | | d14 = | 2.84˜0.20˜0.10 | | | | |
| r15* = | 3.880 | | | | | | |
| | | d15 = | 2.17 | N8 = | 1.487490 | ν8 = | 70.44 |
| r16 = | −35.992 | | | | | | |
| | | d16 = | 0.33 | | | | |
| r17 = | 9.979 | | | | | | |
| | | d17 = | 1.98 | N9 = | 1.487490 | ν9 = | 70.44 |
| r18 = | −7.299 | | | | | | |
| | | d18 = | 0.15 | | | | |
| r19 = | −6.274 | | | | | | |
| | | d19 = | 2.67 | N10 = | 1.846836 | ν10 = | 24.34 |
| r20 = | −22.235 | | | | | | |
| | | d20 = | 0.22 | | | | |
| r21* = | −49.128 | | | | | | |
| | | d21 = | 3.47 | N11 = | 1.527547 | ν11 = | 63.51 |
| r22* = | 16.004 | | | | | | |
| | | d22 = | 0.52˜3.16˜3.25 | | | | |
| r23 = | ∞ | | | | | | |
| | | d23 = | 3.70 | N12 = | 1.516800 | ν12 = | 64.20 |
| r24 = | ∞ | | | | | | |

[Aspherical Coefficient]
r11

| | |
|---|---|
| ε = | 1.0000 |
| A4 = | −1.51649 * 10⁻³ |
| A6 = | 2.66548 * 10⁻⁵ |
| A8 = | 1.22282 * 10⁻⁵ |
| A10 = | −1.32300 * 10⁻⁶ |
| A12 = | 4.92614 * 10⁻⁸ |

r13

| | |
|---|---|
| ε = | 1.0000 |
| A4 = | −3.23885 * 10⁻³ |
| A6 = | 3.40371 * 10⁻⁵ |
| A8 = | 2.06254 * 10⁻⁵ |
| A10 = | −3.68376 * 10⁻⁶ |
| A12 = | 2.02326 * 10⁻⁷ |

r15

| | |
|---|---|
| ε = | 1.0000 |
| A4 = | −1.12558 * 10⁻³ |
| A6 = | −8.48960 * 10⁻⁵ |
| A8 = | 3.21273 * 10⁻⁶ |
| A10 = | −1.83274 * 10⁻⁷ |
| A12 = | −3.06639 * 10⁻⁸ |

r21

| | |
|---|---|
| ε = | 1.0000 |
| A4 = | −7.38365 * 10⁻³ |
| A6 = | −2.15053 * 10⁻⁴ |
| A8 = | −9.38824 * 10⁻⁵ |
| A10 = | 9.96727 * 10⁻⁶ |
| A12 = | −1.04625 * 10⁻⁶ |

r22

| | |
|---|---|
| ε = | 1.0000 |
| A4 = | −3.78250 * 10⁻³ |
| A6 = | −2.14667 * 10⁻⁴ |
| A8 = | 6.93245 * 10⁻⁵ |
| A10 = | −1.13196 * 10⁻⁵ |
| A12 = | 7.18551 * 10⁻⁷ |

TABLE 4
[Embodiment 4]

| | |
|---|---|
| f = | 5.10˜16.00˜48.69 |
| FNO = | 3.22˜4.10˜4.10 |

| | | | |
|---|---|---|---|
| Radius of | Axial | Refractive | Abbe |
| Curvature | Distance | Index | Number |

| r1 = | 30.563 | | | | | | |
|---|---|---|---|---|---|---|---|
| | | d1 = | 0.60 | N1 = | 1.818759 | ν1 = | 23.23 |
| r2 = | 14.423 | | | | | | |
| | | d2 = | 2.62 | N2 = | 1.642484 | ν2 = | 56.38 |
| r3 = | 502.675 | | | | | | |
| | | d3 = | 0.10 | | | | |
| r4 = | 12.680 | | | | | | |
| | | d4 = | 1.71 | N3 = | 1.754500 | ν3 = | 51.57 |
| r5 = | 32.327 | | | | | | |
| | | d5 = | 0.50˜5.68˜9.82 | | | | |
| r6* = | 31.105 | | | | | | |
| | | d6 = | 0.60 | N4 = | 1.713476 | ν4 = | 53.06 |
| r7* = | 4.594 | | | | | | |
| | | d7 = | 3.10 | | | | |
| r8 = | −4.932 | | | | | | |
| | | d8 = | 0.60 | N5 = | 1.697627 | ν5 = | 53.71 |
| r9 = | 8.955 | | | | | | |
| | | d9 = | 1.01 | N6 = | 1.813453 | ν6 = | 22.98 |
| r10 = | −25.524 | | | | | | |
| | | d10 = | 10.19˜4.78˜0.50 | | | | |
| r11 = | ∞ | | | | | | |
| | | d11 = | 0.10 | | | | |
| r12 = | 4.921 | | | | | | |
| | | d12 = | 1.66 | N7 = | 1.676156 | ν7 = | 50.74 |
| r13 = | −95.562 | | | | | | |
| | | d13 = | 0.85 | | | | |
| r14* = | −181.749 | | | | | | |
| | | d14 = | 1.16 | N8 = | 1.847905 | ν8 = | 28.07 |
| r15* = | 5.217 | | | | | | |
| | | d15 = | 0.12 | | | | |
| r16 = | 5.230 | | | | | | |
| | | d16 = | 1.65 | N9 = | 1.495513 | ν9 = | 64.74 |
| r17 = | −9.579 | | | | | | |
| | | d17 = | 5.16 | | | | |
| r18* = | −4955.676 | | | | | | |
| | | d18 = | 3.36 | N10 = | 1.807490 | ν10 = | 44.15 |
| r19* = | 136.647 | | | | | | |
| | | d19 = | 0.50˜5.55˜8.24 | | | | |
| r20 = | ∞ | | | | | | |
| | | d20 = | 3.40 | N11 = | 1.516800 | ν11 = | 64.20 |
| r21 = | ∞ | | | | | | |

[Aspherical Coefficient]
r6

| | |
|---|---|
| ε = | 1.0000 |
| A4 = | 7.61844 * 10⁻⁴ |
| A6 = | −3.34498 * 10⁻⁵ |
| A8 = | 1.91322 * 10⁻⁶ |
| A10 = | −3.06438 * 10⁻⁸ |
| A12 = | 1.77936 * 10⁻¹⁰ |

r7

| | |
|---|---|
| ε = | 1.0000 |
| A4 = | 5.09017 * 10⁻⁴ |
| A6 = | −4.07384 * 10⁻⁵ |
| A8 = | 1.60395 * 10⁻⁵ |
| A10 = | −2.56405 * 10⁻⁶ |
| A12 = | 1.79225 * 10⁻⁷ |

r14

| | |
|---|---|
| ε = | 1.0000 |
| A4 = | −1.63035 * 10⁻³ |
| A6 = | 4.61794 * 10⁻⁵ |
| A8 = | 2.66015 * 10⁻⁶ |
| A10 = | −9.53202 * 10⁻⁸ |
| A12 = | −2.86433 * 10⁻⁸ |

r15

| | |
|---|---|
| ε = | 1.0000 |
| A4 = | 2.43530 * 10⁻⁴ |
| A6 = | 7.95268 * 10⁻⁵ |
| A8 = | 9.79297 * 10⁻⁶ |
| A10 = | 2.58484 * 10⁻⁷ |
| A12 = | −1.14984 * 10⁻⁷ |

r18

| | |
|---|---|
| ε = | 1.0000 |
| A4 = | −9.11167 * 10⁻⁴ |
| A6 = | −2.73536 * 10⁻⁵ |
| A8 = | 2.88114 * 10⁻⁶ |
| A10 = | 9.33187 * 10⁻⁹ |
| A12 = | −5.33332 * 10⁻⁸ |

r19

| | |
|---|---|
| ε = | 1.0000 |
| A4 = | −1.03703 * 10⁻³ |
| A6 = | 1.21604 * 10⁻⁵ |
| A8 = | −5.10027 * 10⁻⁷ |
| A10 = | −1.25593 * 10⁻⁷ |
| A12 = | −7.60189 * 10⁻¹⁰ |

TABLE 5
[Embodiment 5]

| | |
|---|---|
| f = | 5.12˜15.50˜48.75 |
| FNO = | 2.73˜4.31˜4.10 |

| | | | |
|---|---|---|---|
| Radius of | Axial | Refractive | Abbe |
| Curvature | Distance | Index | Number |

| r1 = | 34.255 | | | | | | |
|---|---|---|---|---|---|---|---|
| | | d1 = | 0.60 | N1 = | 1.847049 | ν1 = | 25.00 |
| r2 = | 24.307 | | | | | | |
| | | d2 = | 0.16 | | | | |
| r3 = | 24.992 | | | | | | |
| | | d3 = | 3.41 | N2 = | 1.487490 | ν2 = | 70.44 |
| r4 = | −114.984 | | | | | | |
| | | d4 = | 0.10 | | | | |
| r5 = | 20.927 | | | | | | |
| | | d5 = | 1.29 | N3 = | 1.565362 | ν3 = | 61.66 |
| r6 = | 31.362 | | | | | | |
| | | d6 = | 0.10˜12.78˜23.33 | | | | |
| r7 = | 17.176 | | | | | | |
| | | d7 = | 0.60 | N4 = | 1.847831 | ν4 = | 27.77 |
| r8 = | 5.655 | | | | | | |
| | | d8 = | 3.63 | | | | |
| r9 = | 22.850 | | | | | | |
| | | d9 = | 1.20 | N5 = | 1.798500 | ν5 = | 22.60 |
| r10 = | −13.011 | | | | | | |
| | | d10 = | 0.73 | | | | |
| r11* = | −7.768 | | | | | | |
| | | d11 = | 0.75 | N6 = | 1.798500 | ν6 = | 22.60 |
| r12 = | −5.134 | | | | | | |
| | | d12 = | 0.60 | N7 = | 1.761352 | ν7 = | 50.41 |
| r13* = | 12.571 | | | | | | |
| | | d13 = | 6.88˜2.11˜0.32 | | | | |
| r14 = | ∞ | | | | | | |
| | | d14 = | 3.00˜2.00˜0.10 | | | | |
| r15 = | 6.826 | | | | | | |
| | | d15 = | 1.12 | N8 = | 1.586416 | ν8 = | 59.98 |
| r16 = | 43.123 | | | | | | |
| | | d16 = | 0.10 | | | | |
| r17 = | 5.588 | | | | | | |
| | | d17 = | 2.84 | N9 = | 1.517966 | ν9 = | 66.40 |
| r18 = | −8.166 | | | | | | |
| | | d18 = | 0.35 | | | | |
| r19 = | −6.587 | | | | | | |
| | | d19 = | 1.09 | N10 = | 1.784209 | ν10 = | 29.06 |
| r20 = | 9.397 | | | | | | |
| | | d20 = | 1.80 | | | | |
| r21 = | 3.568 | | | | | | |
| | | d21 = | 1.30 | N11 = | 1.531829 | ν11 = | 64.85 |
| r22* = | 8.075 | | | | | | |
| | | d22 = | 3.19˜7.89˜12.83 | | | | |
| r23 = | ∞ | | | | | | |
| | | d23 = | 3.70 | N12 = | 1.516800 | ν12 = | 64.20 |
| r24 = | ∞ | | | | | | |

[Aspherical Coefficient]
r11

| | |
|---|---|
| ε = | 1.0000 |
| A4 = | −8.09441 * 10⁻⁴ |
| A6 = | −3.81431 * 10⁻⁵ |
| A8 = | 2.03843 * 10⁻⁵ |
| A10 = | −1.95474 * 10⁻⁶ |
| A12 = | 6.29809 * 10⁻⁸ |

r13

| | |
|---|---|
| ε = | 1.0000 |
| A4 = | −1.57384 * 10⁻³ |
| A6 = | −3.00291 * 10⁻⁵ |
| A8 = | 2.34322 * 10⁻⁵ |
| A10 = | −2.90404 * 10⁻⁶ |
| A12 = | 1.29620 * 10⁻⁷ |

r22

| | |
|---|---|
| ε = | 1.0000 |
| A4 = | 6.06134 * 10⁻³ |
| A6 = | 1.34200 * 10⁻⁵ |
| A8 = | 6.72379 * 10⁻⁵ |
| A10 = | −9.58951 * 10⁻⁶ |
| A12 = | 7.15528 * 10⁻⁷ |

TABLE 6
[Embodiment 6]

| | |
|---|---|
| f = | 5.12˜15.50˜48.75 |
| FNO = | 2.26˜2.77˜4.10 |

| | | | |
|---|---|---|---|
| Radius of | Axial | Refractive | Abbe |
| Curvature | Distance | Index | Number |

| r1 = | 53.711 | | | | | | |
|---|---|---|---|---|---|---|---|
| | | d1 = | 0.60 | N1 = | 1.798500 | ν1 = | 22.60 |
| r2 = | 27.004 | | | | | | |
| | | d2 = | 3.20 | N2 = | 1.754500 | ν2 = | 51.57 |
| r3 = | −1101.306 | | | | | | |
| | | d3 = | 0.10 | | | | |
| r4 = | 21.200 | | | | | | |
| | | d4 = | 1.97 | N3 = | 1.487490 | ν3 = | 70.44 |
| r5 = | 38.384 | | | | | | |
| | | d5 = | 0.10˜13.58˜20.46 | | | | |
| r6 = | 10.109 | | | | | | |
| | | d6 = | 0.60 | N4 = | 1.849967 | ν4 = | 39.77 |
| r7* = | 5.358 | | | | | | |
| | | d7 = | 2.37 | | | | |
| r8 = | −64.671 | | | | | | |
| | | d8 = | 0.60 | N5 = | 1.850000 | ν5 = | 40.04 |
| r9 = | 8.081 | | | | | | |
| | | d9 = | 0.10 | | | | |
| r10 = | 7.801 | | | | | | |
| | | d10 = | 1.90 | N6 = | 1.798500 | ν6 = | 22.60 |
| r11 = | −16.817 | | | | | | |
| | | d11 = | 1.03 | | | | |
| r12 = | −6.936 | | | | | | |
| | | d12 = | 0.60 | N7 = | 1.785779 | ν7 = | 46.80 |
| r13* = | 130.561 | | | | | | |
| | | d13 = | 9.15˜3.84˜0.11˜ | | | | |
| r14 = | ∞ | | | | | | |
| | | d14 = | 0.82˜0.89˜0.10 | | | | |
| r15* = | 8.023 | | | | | | |
| | | d15 = | 1.23 | N8 = | 1.674291 | ν8 = | 54.76 |
| r16 = | −62.203 | | | | | | |
| | | d16 = | 0.10 | | | | |
| r17 = | 5.569 | | | | | | |
| | | d17 = | 1.88 | N9 = | 1.487490 | ν9 = | 70.44 |
| r18 = | −28.528 | | | | | | |
| | | d18 = | 0.10 | | | | |
| r19 = | 10.643 | | | | | | |
| | | d19 = | 0.60 | N10 = | 1.844735 | ν10 = | 23.77 |
| r20 = | 3.803 | | | | | | |
| | | d20 = | 3.07 | | | | |
| r21 = | 6.438 | | | | | | |
| | | d21 = | 4.05 | N11 = | 1.553618 | ν11 = | 42.71 |
| r22* = | 17.611 | | | | | | |
| | | d22 = | 1.05˜4.20˜10.46 | | | | |
| r23 = | ∞ | | | | | | |
| | | d23 = | 3.70 | N12 = | 1.516800 | ν12 = | 64.20 |
| r24 = | ∞ | | | | | | |

[Aspherical Coefficient]
r7

| | |
|---|---|
| ε = | 1.0000 |
| A4 = | 6.46463 * 10⁻⁶ |
| A6 = | 7.12987 * 10⁻⁶ |
| A8 = | −1.62410 * 10⁻⁶ |
| A10 = | 1.48107 * 10⁻⁷ |
| A12 = | −4.68558 * 10⁻⁹ |

r13

| | |
|---|---|
| ε = | 1.0000 |
| A4 = | −4.50773 * 10⁻⁴ |
| A6 = | 1.11988 * 10⁻⁵ |
| A8 = | −1.26713 * 10⁻⁶ |
| A10 = | 7.63556 * 10⁻⁸ |
| A12 = | 4.89912 * 10⁻¹⁰ |

r15

| | |
|---|---|
| ε = | 1.0000 |
| A4 = | −6.88311 * 10⁻⁴ |
| A6 = | −2.40885 * 10⁻⁶ |
| A8 = | −1.07446 * 10⁻⁶ |
| A10 = | 1.21996 * 10⁻⁷ |
| A12 = | −5.39814 * 10⁻⁹ |

r22

| | |
|---|---|
| ε = | 1.0000 |
| A4 = | 7.43446 * 10⁻⁴ |
| A6 = | 3.20186 * 10⁻⁵ |
| A8 = | −1.13515 * 10⁻⁵ |
| A10 = | 1.73213 * 10⁻⁶ |
| A12 = | −9.08995 * 10⁻⁸ |

TABLE 7
[Embodiment 2]

| | |
|---|---|
| f = | 5.10˜16.01˜48.80 |
| FNO = | 3.10˜3.60˜4.20 |

| | | | |
|---|---|---|---|
| Radius of | Axial | Refractive | Abbe |
| Curvature | Distance | Index | Number |

| r1 = | 51.316 | | | | | | |
|---|---|---|---|---|---|---|---|
| | | d1 = | 0.60 | N1 = | 1.818759 | ν1 = | 23.23 |
| r2 = | 21.286 | | | | | | |
| | | d2 = | 2.15 | N2 = | 1.642484 | ν2 = | 56.38 |
| r3 = | −145.048 | | | | | | |
| | | d3 = | 0.10 | | | | |
| r4 = | 16.706 | | | | | | |
| | | d4 = | 1.36 | N3 = | 1.754500 | ν3 = | 51.57 |
| r5 = | 35.177 | | | | | | |
| | | d5 = | 0.50˜7.83˜15.62 | | | | |
| r6* = | 24.341 | | | | | | |
| | | d6 = | 0.60 | N4 = | 1.713476 | ν4 = | 53.06 |
| r7* = | 6.094 | | | | | | |
| | | d7 = | 3.72 | | | | |
| r8 = | −5.140 | | | | | | |
| | | d8 = | 0.22 | N5 = | 1.697627 | ν5 = | 53.71 |
| r9 = | 9.515 | | | | | | |
| | | d9 = | 0.75 | N6 = | 1.813453 | ν6 = | 22.98 |
| r10 = | −31.907 | | | | | | |
| | | d10 = | 10.45˜4.50˜0.40 | | | | |
| r11 = | ∞ | | | | | | |
| | | d11 = | 0.10 | | | | |
| r12* = | 4.781 | | | | | | |
| | | d12 = | 1.33 | N7 = | 1.727475 | ν7 = | 46.05 |
| r13 = | −35.839 | | | | | | |
| | | d13 = | 0.10 | | | | |
| r14 = | 239.202 | | | | | | |
| | | d14 = | 2.25 | N8 = | 1.755000 | ν8 = | 27.60 |
| r15 = | 4.906 | | | | | | |
| | | d15 = | 0.10 | | | | |
| r16 = | 5.581 | | | | | | |
| | | d16 = | 0.22 | N9 = | 1.747052 | ν9 = | 38.08 |
| r17 = | 2.897 | | | | | | |
| | | d17 = | 1.40 | N10 = | 1.487000 | ν10 = | 70.40 |
| r18 = | 32.525 | | | | | | |
| | | d18 = | 0.84 | | | | |
| r19* = | 6.428 | | | | | | |
| | | d19 = | 0.69 | N11 = | 1.532956 | ν11 = | 51.14 |
| r20 = | 33.260 | | | | | | |
| | | d20 = | 1.38˜6.57˜5.88 | | | | |
| r21 = | ∞ | | | | | | |
| | | d21 = | 3.40 | N12 = | 1.516800 | ν12 = | 64.20 |
| r22 = | ∞ | | | | | | |

[Aspherical Coefficient]
r6

| | |
|---|---|
| ε = | 1.0000 |
| A4 = | 1.19413 * 10⁻³ |
| A6 = | −5.05252 * 10⁻⁵ |
| A8 = | 2.33263 * 10⁻⁶ |
| A10 = | −7.39707 * 10⁻⁸ |
| A12 = | 1.22559 * 10⁻⁹ |

r7

| | |
|---|---|
| ε = | 1.0000 |
| A4 = | 1.12929 * 10⁻³ |
| A6 = | −2.79368 * 10⁻⁵ |
| A8 = | 2.71069 * 10⁻⁶ |
| A10 = | −2.07291 * 10⁻⁷ |
| A12 = | 5.55089 * 10⁻⁹ |

r12

| | |
|---|---|
| ε = | 1.0000 |
| A4 = | −7.09501 * 10⁻⁴ |
| A6 = | −1.37096 * 10⁻⁵ |
| A8 = | −2.32713 * 10⁻⁶ |
| A10 = | 7.09276 * 10⁻⁸ |

r19

| | |
|---|---|
| ε = | 1.0000 |
| A4 = | −9.92974 * 10⁻⁴ |
| A6 = | 1.23299 * 10⁻⁵ |
| A8 = | 1.61718 * 10⁻⁶ |
| A10 = | 3.97318 * 10⁻⁷ |

TABLE 8
[Embodiment 8]

| | |
|---|---|
| f = | 5.10˜16.00˜49.00 |
| FNO = | 3.66˜3.39˜4.090 |

| | | | |
|---|---|---|---|
| Radius of | Axial | Refractive | Abbe |
| Curvature | Distance | Index | Number |

| r1 = | 31.528 | | | | | | |
|---|---|---|---|---|---|---|---|
| | | d1 = | 0.70 | N1 = | 1.833500 | ν1 = | 21.00 |
| r2 = | 21.419 | | | | | | |
| | | d2 = | 0.55 | | | | |
| r3 = | 22.092 | | | | | | |
| | | d3 = | 3.72 | N2 = | 1.570699 | ν2 = | 61.21 |
| r4 = | −144.544 | | | | | | |
| | | d4 = | 0.08 | | | | |
| r5 = | 16.481 | | | | | | |
| | | d5 = | 1.29 | N3 = | 1.487490 | ν3 = | 70.44 |
| r6 = | 28.275 | | | | | | |
| | | d6 = | 0.80˜11.02˜17.42 | | | | |
| r7 = | 14.115 | | | | | | |
| | | d7 = | 0.57 | N4 = | 1.771126 | ν4 = | 48.87 |
| r8 = | 5.297 | | | | | | |
| | | d8 = | 3.36 | | | | |
| r9 = | −9.862 | | | | | | |
| | | d9 = | 0.30 | N5 = | 1.754500 | ν5 = | 51.57 |
| r10 = | 10.625 | | | | | | |
| | | d10 = | 0.08 | | | | |
| r11* = | 8.323 | | | | | | |
| | | d11 = | 1.01 | N6 = | 1.846660 | ν6 = | 23.82 |
| r12* = | 93.502 | | | | | | |
| | | d12 = | 10.85˜2.53˜0.90 | | | | |
| r13 = | ∞ | | | | | | |
| | | d13 = | 6.80˜6.40˜0.90 | | | | |
| r14 = | 6.632 | | | | | | |
| | | d14 = | 1.10 | N7 = | 1.487490 | ν7 = | 70.44 |
| r15 = | 40.054 | | | | | | |
| | | d15 = | 0.08 | | | | |
| r16 = | 5.007 | | | | | | |
| | | d16 = | 2.29 | N8 = | 1.487490 | ν8 = | 70.44 |
| r17 = | −127.484 | | | | | | |
| | | d17 = | 0.32 | | | | |
| r18* = | 6.494 | | | | | | |
| | | d18 = | 0.40 | N9 = | 1.846660 | ν9 = | 23.82 |
| r19* = | 3.815 | | | | | | |
| | | d19 = | 4.05˜7.35˜10.55 | | | | |
| r20 = | ∞ | | | | | | |
| | | d20 = | 7.19 | N10 = | 1.516800 | ν10 = | 64.20 |
| r21 = | ∞ | | | | | | |

[Aspherical Coefficient]
r11

| | |
|---|---|
| ε = | 1.0000 |
| A4 = | −2.70853 * 10⁻⁴ |
| A6 = | 5.51414 * 10⁻⁵ |
| A8 = | −4.74840 * 10⁻⁶ |

r12

| | |
|---|---|
| ε = | 1.0000 |
| A4 = | −1.51231 * 10⁻⁴ |
| A6 = | 7.16807 * 10⁻⁵ |
| A8 = | −5.10893 * 10⁻⁶ |

r18

| | |
|---|---|
| ε = | 1.0000 |
| A4 = | −4.13231 * 10⁻³ |
| A6 = | 2.22876 * 10⁻⁴ |
| A8 = | −2.21116 * 10⁻⁵ |
| A10 = | 7.83601 * 10⁻⁷ |

r19

| | |
|---|---|
| ε = | 1.0000 |
| A4 = | −3.12685 * 10⁻³ |
| A6 = | 2.80257 * 10⁻⁴ |
| A8 = | −1.80966 * 10⁻⁵ |
| A10 = | 2.22654 * 10⁻⁷ |

TABLE 9
[Embodiment 9]

| | |
|---|---|
| f = | 5.12˜15.50˜48.74 |
| FNO = | 2.64˜3.60˜4.10 |

| | | | |
|---|---|---|---|
| Radius of | Axial | Refractive | Abbe |
| Curvature | Distance | Index | Number |

| r1 = | 29.000 | | | | | | |
|---|---|---|---|---|---|---|---|
| | | d1 = | 0.60 | N1 = | 1.846920 | ν1 = | 24.60 |
| r2 = | 16.360 | | | | | | |
| | | d2 = | 4.84 | N2 = | 1.596439 | ν2 = | 59.25 |
| r3 = | −62.939 | | | | | | |
| | | d3 = | 0.10 | | | | |
| r4 = | 13.488 | | | | | | |
| | | d4 = | 1.80 | N3 = | 1.599568 | ν3 = | 59.03 |
| r5 = | 21.436 | | | | | | |
| | | d5 = | 1.02˜6.95˜12.11 | | | | |
| r6 = | 30.493 | | | | | | |
| | | d6 = | 0.60 | N4 = | 1.754500 | ν4 = | 51.57 |
| r7* = | 4.294 | | | | | | |
| | | d7 = | 2.36 | | | | |
| r8 = | −4.433 | | | | | | |
| | | d8 = | 0.60 | N5 = | 1.582062 | ν5 = | 60.31 |
| r9 = | 10.934 | | | | | | |
| | | d9 = | 0.10 | | | | |
| r10 = | 11.027 | | | | | | |
| | | d10 = | 0.94 | N6 = | 1.819163 | ν6 = | 23.13 |
| r11 = | −37.256 | | | | | | |
| | | d11 = | 8.65˜3.56˜0.10 | | | | |
| r12 = | ∞ | | | | | | |
| | | d12 = | 0.10 | | | | |
| r13* = | 6.496 | | | | | | |
| | | d13 = | 1.42 | N7 = | 1.612875 | ν7 = | 58.14 |
| r14 = | −32.051 | | | | | | |
| | | d14 = | 1.18 | | | | |
| r15 = | 15.039 | | | | | | |
| | | d15 = | 1.86 | N8 = | 1.846758 | ν8 = | 24.11 |
| r16 = | 5.085 | | | | | | |
| | | d16 = | 0.30 | | | | |
| r17 = | 6.436 | | | | | | |
| | | d17 = | 1.94 | N9 = | 1.487490 | ν9 = | 70.44 |
| r18* = | −8.524 | | | | | | |
| | | d18 = | 7.17˜5.52˜8.22 | | | | |
| r19 = | ∞ | | | | | | |
| | | d19 = | 7.19 | N10 = | 1.516800 | ν10 = | 64.20 |
| r20 = | ∞ | | | | | | |

[Aspherical Coefficient]
r7

| | |
|---|---|
| ε = | 1.0000 |
| A4 = | −4.65301 * 10⁻⁴ |
| A6 = | −5.36672 * 10⁻⁵ |
| A8 = | 2.88202 * 10⁻⁵ |
| A10 = | −5.10403 * 10⁻⁶ |
| A12 = | 2.60914 * 10⁻⁷ |

r13

| | |
|---|---|
| ε = | 1.0000 |
| A4 = | −7.89688 * 10⁻⁴ |
| A6 = | −3.19583 * 10⁻⁶ |
| A8 = | 5.47654 * 10⁻⁷ |
| A10 = | −6.96840 * 10⁻⁸ |

r18

| | |
|---|---|
| ε = | 1.0000 |
| A4 = | 1.53515 * 10⁻⁴ |
| A6 = | −1.43399 * 10⁻⁵ |
| A8 = | −9.20984 * 10⁻⁷ |
| A10 = | 1.03766 * 10⁻⁷ |
| A12 = | −2.46150 * 10⁻⁸ |

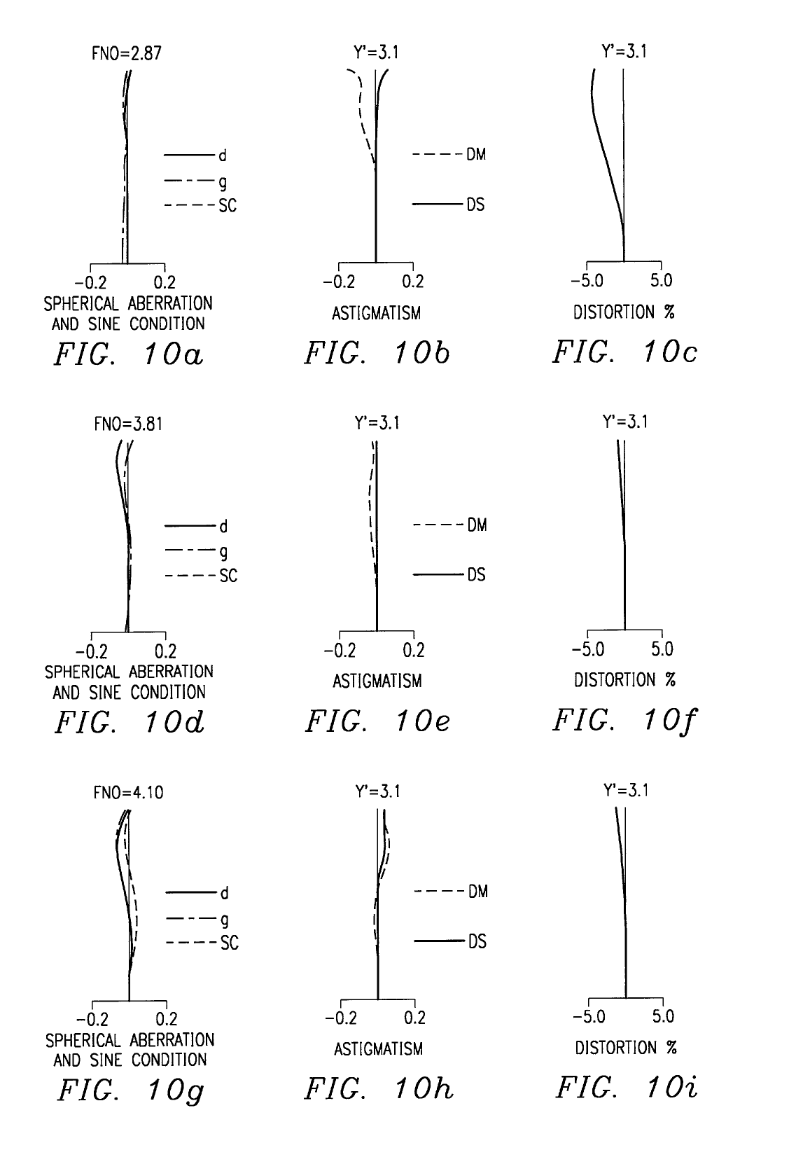

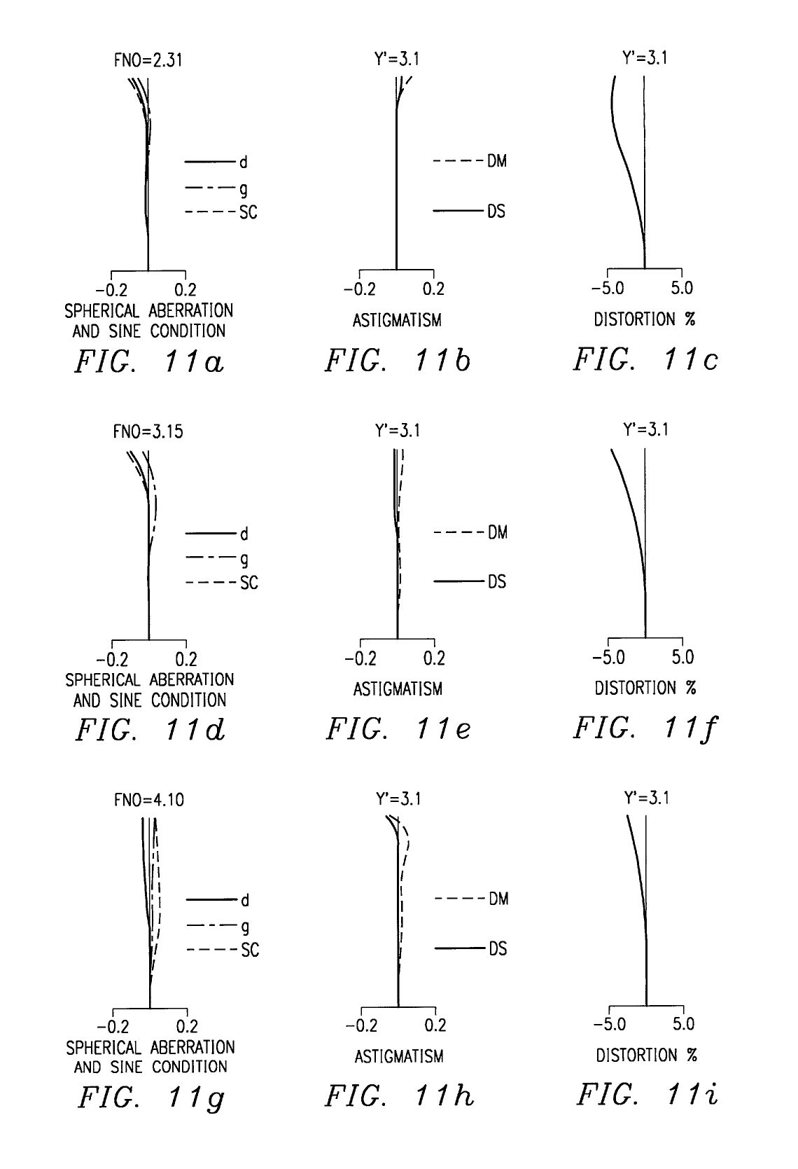

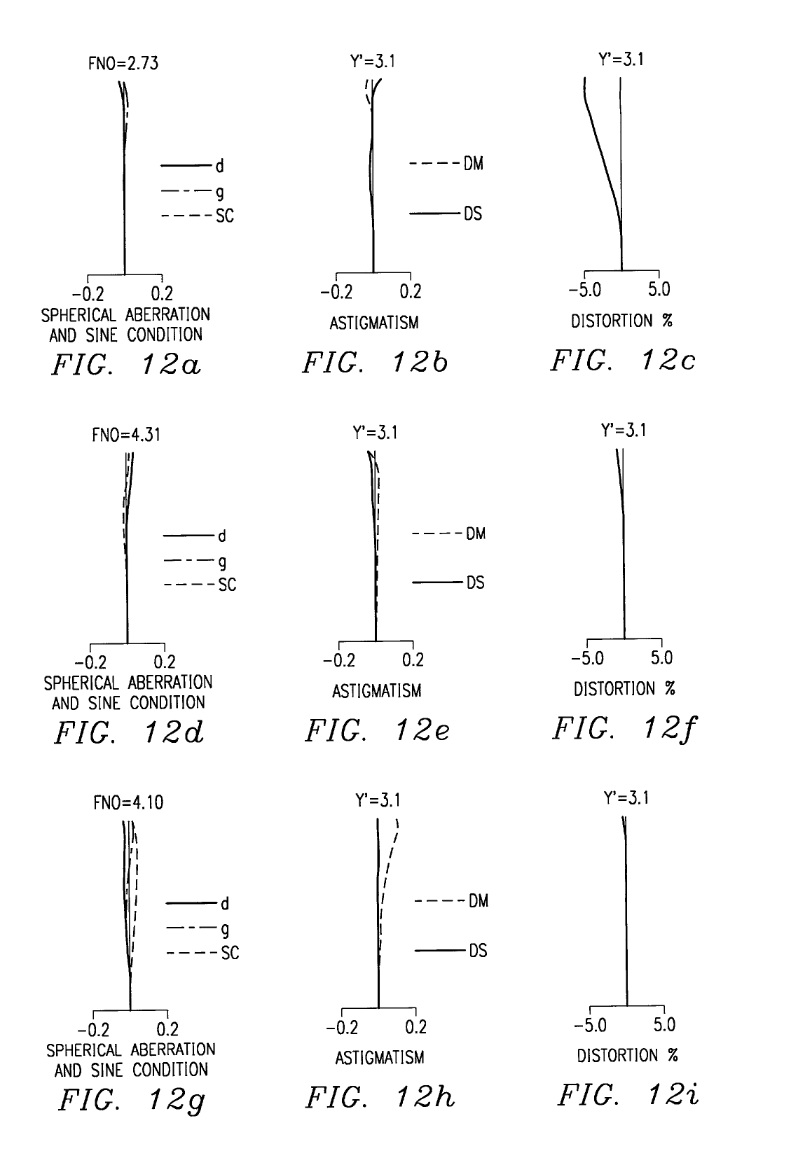

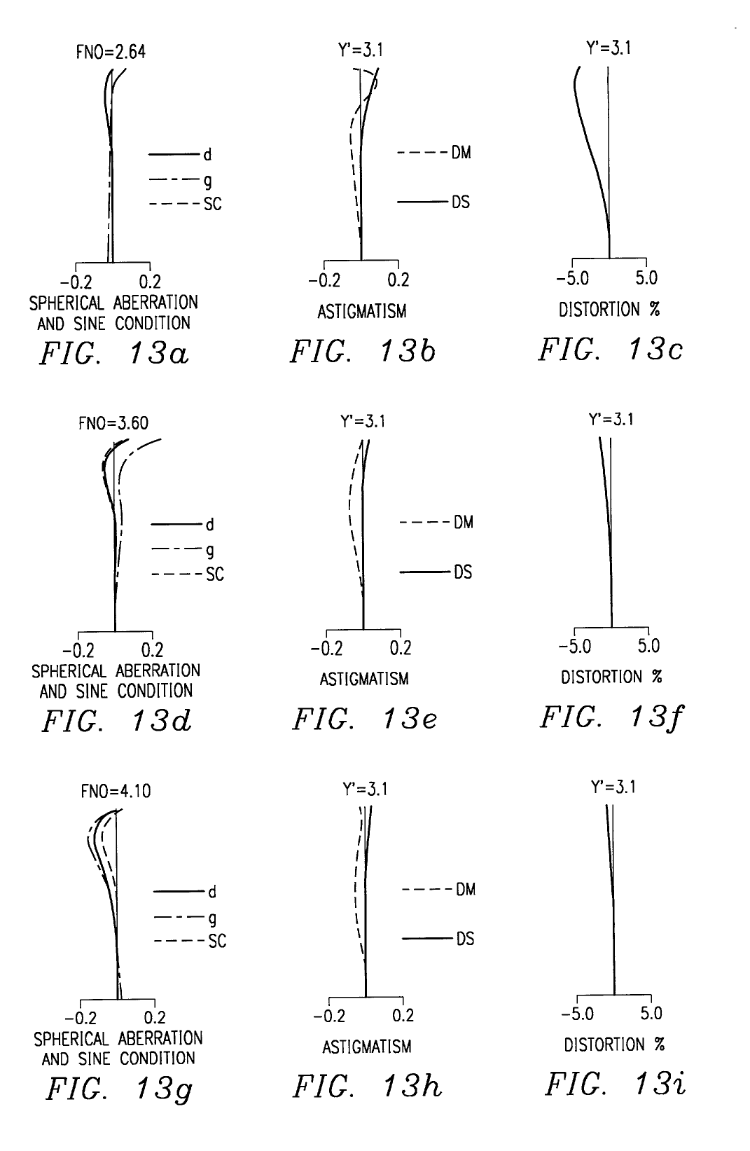

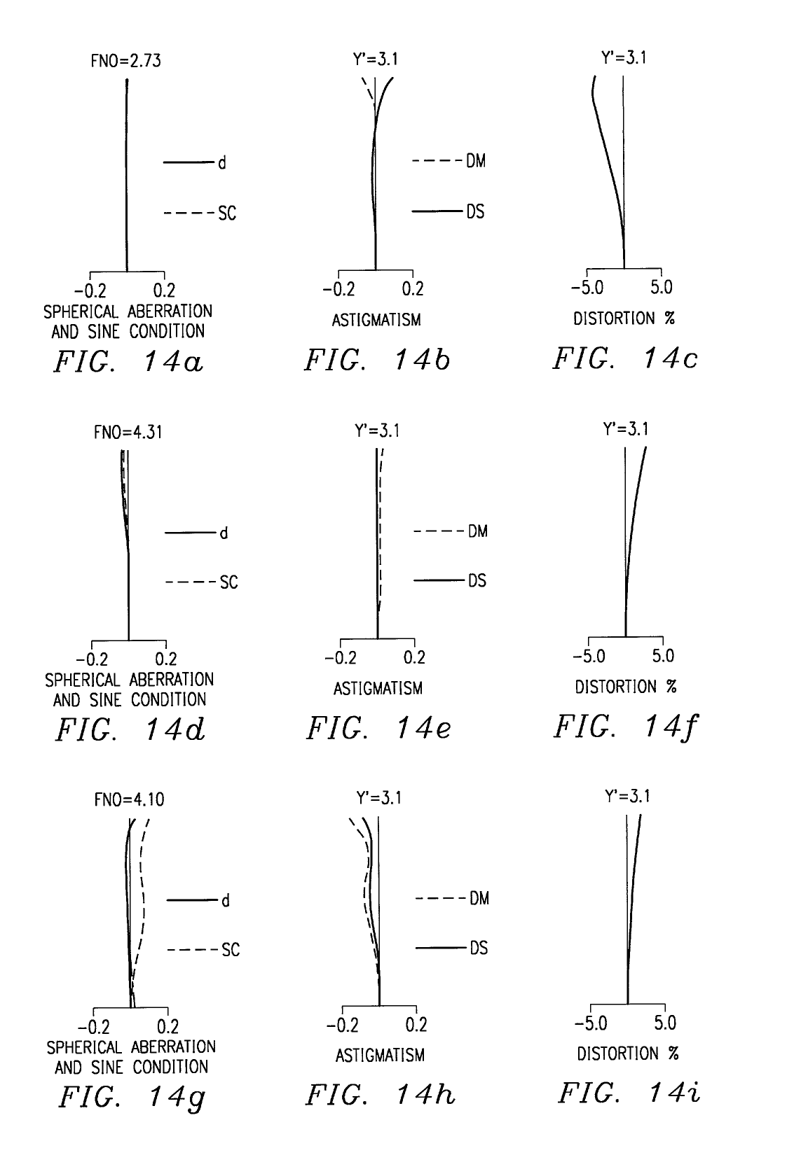

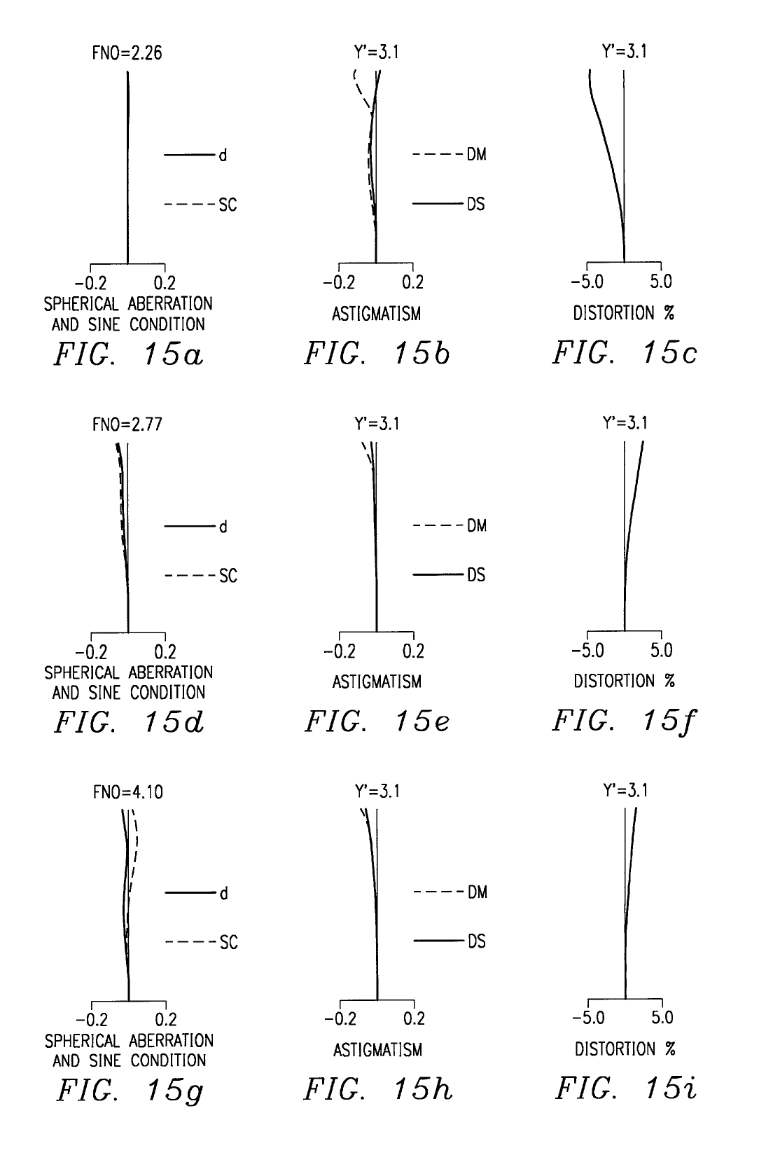

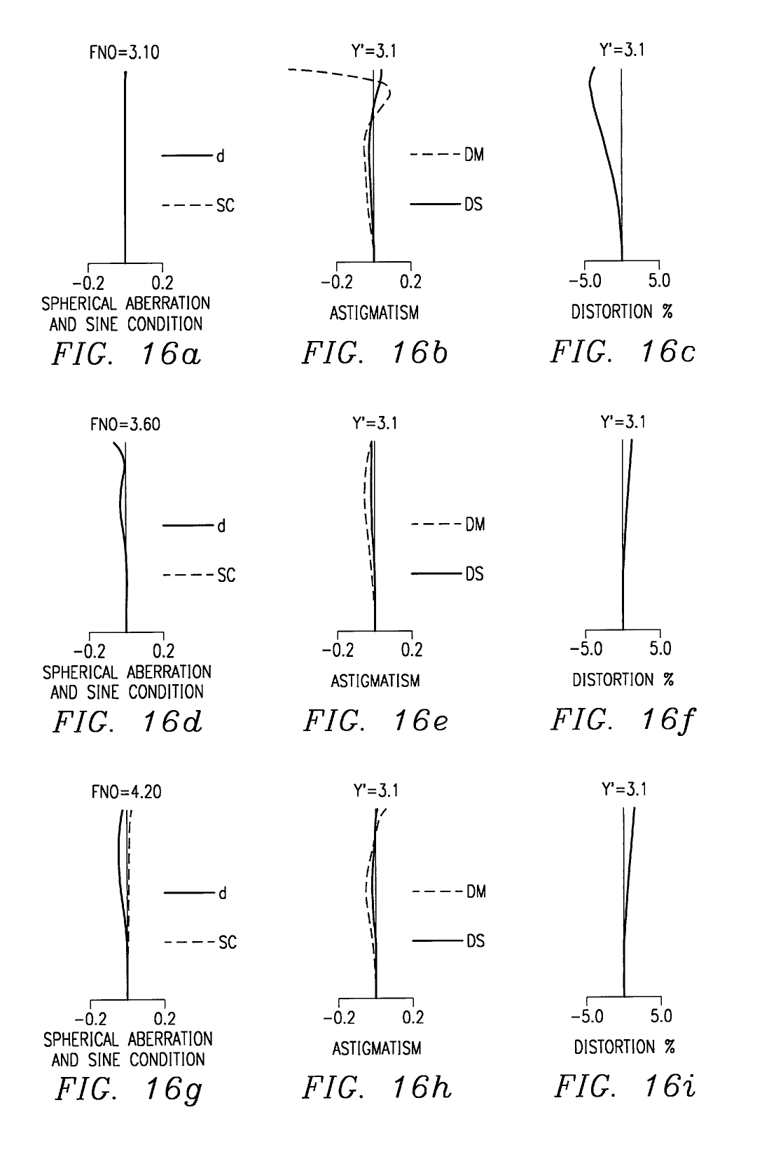

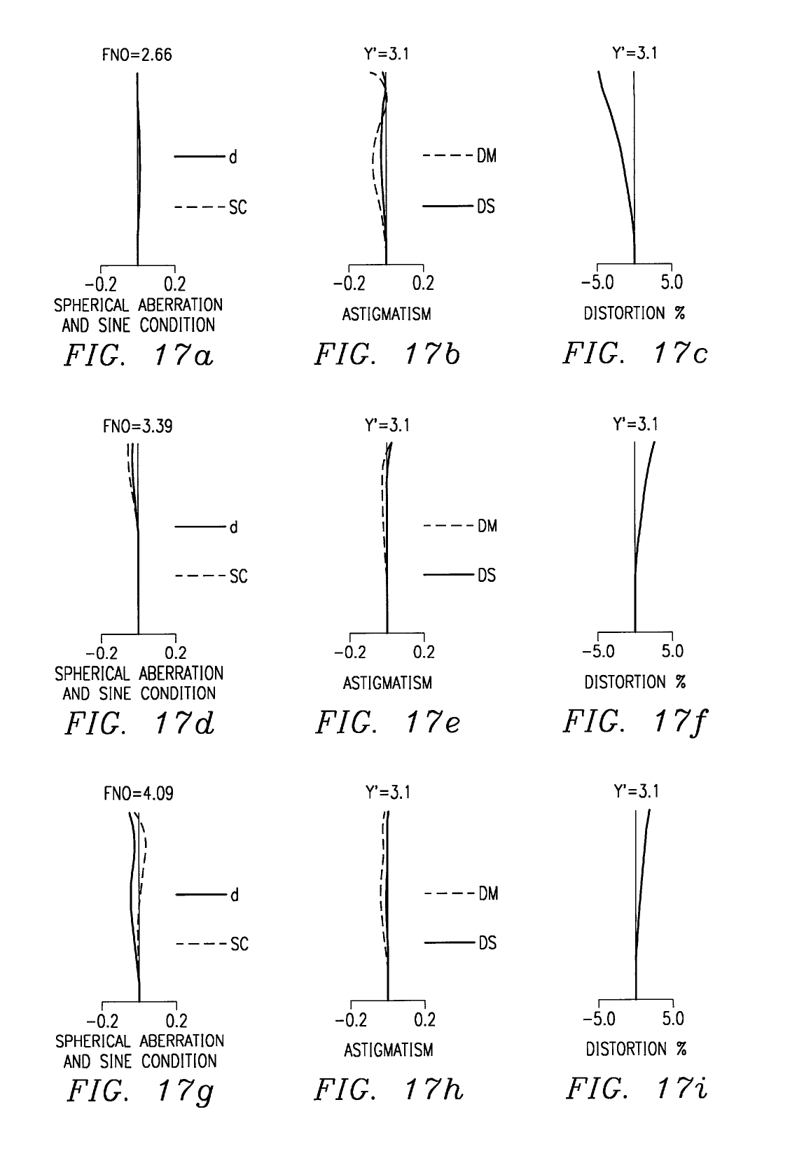

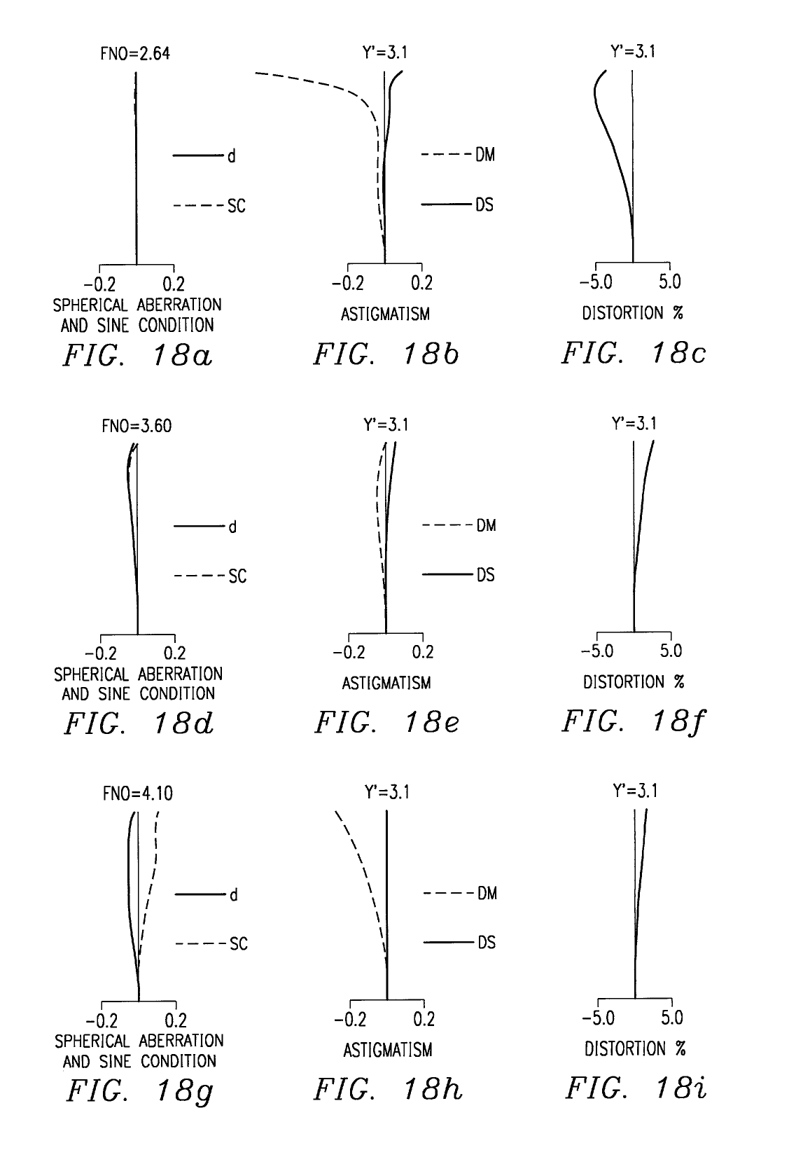

FIGS. 10 to 18 are aberration diagrams respectively corresponding to Embodiments 1 to 9 described above. In these figure descriptions, the suffix (a), (b), or (c) indicates a diagram at the wide angle end, the suffix (d), (e) or (f) indicates a diagram at the middle focal length condition, and the suffix (g), (h) or (i) indicates a diagram at the telephoto end. In the spherical aberration diagrams of the figures with the suffix (a), (d), or (g), the solid line (d) indicates the d line, and the broken line (sc) indicates a sine condition. In the astigmatism diagrams of the figures with the suffixes (b), (e), or (h), the solid line (DS) and the broken line (DM) indicate astigmatisms of the sagittal flux and the meridional flux, respectively. Furthermore, the figures with the suffix (c), (f), or (i) are distortion aberration diagrams. Table 10 shows values corresponding to the conditional expressions in Embodiments 1 to 9.

TABLE 10
[Embodiment 1]

| | | |
|---|---|---|
| (1) | f1/f1W: | 7.30 |
| (2) | f2/f1W: | −0.97 |
| (3) | f3/f1W: | 1.60 |
| (4) | img * R: | 8.1 |
| (5) | Ra/f3: | 0.60 |
| (6) | R2n/f2: | −0.89 |
| (6)′ | f2p/f2: | — |
| (7) | νn: | 30.68 |
| (8) | νp: | 70.44 |
| (9) | m1/Z: | 2.09 |
| (10) | M1WM/M1MT: | 1.37 |
| (11) | max(T1,T2,T3)/f1W: | 2.76 |
| (12) | Lw/f1W: | 7.80 |
| (13) | Δβ3/Δβ2: | 0.447 |
| (14) | βT2/βw2: | 4.62 |
| (15) | fT/\|f12W\|: | 7.34 |
| (16) | φ * (N′ − N) * d/dH{X(H) − X0(H)} | |

| | |
|---|---|
| r6 | |
| 0.1 Hmax | 0.3049E−05 |
| 0.2 Hmax | 0.2457E−04 |
| 0.3 Hmax | 0.8438E−04 |
| 0.4 Hmax | 0.2067E−03 |
| 0.5 Hmax | 0.4242E−03 |
| 0.6 Hmax | 0.7813E−03 |
| 0.7 Hmax | 0.1341E−02 |
| 0.8 Hmax | 0.2226E−02 |
| 0.9 Hmax | 0.3774E−02 |
| 1.0 Hmax | 0.7007E−02 |
| r7 | |
| 0.1 Hmax | 0.1297E−05 |
| 0.2 Hmax | 0.1048E−04 |
| 0.3 Hmax | 0.3933E−04 |
| 0.4 Hmax | 0.1182E−03 |
| 0.5 Hmax | 0.3154E−03 |
| 0.6 Hmax | 0.7440E−03 |
| 0.7 Hmax | 0.1587E−02 |
| 0.8 Hmax | 0.3342E−02 |
| 0.9 Hmax | 0.7882E−02 |
| 1.0 Hmax | 0.2168E−01 |

| | |
|---|---|
| (17) | φ * (N′ − N) * d/dH{X(H) − X0(H)} |

| | |
|---|---|
| r14 | |
| 0.1 Hmax | −0.1376E−05 |
| 0.2 Hmax | −0.1096E−04 |
| 0.3 Hmax | −0.3674E−04 |
| 0.4 Hmax | −0.8634E−04 |
| 0.5 Hmax | −0.1670E−03 |
| 0.6 Hmax | −0.2856E−03 |
| 0.7 Hmax | −0.4493E−03 |
| 0.8 Hmax | −0.6655E−03 |
| 0.9 Hmax | −0.9425E−03 |
| 1.0 Hmax | −0.1289E−02 |
| r15 | |
| 0.1 Hmax | 0.2247E−05 |
| 0.2 Hmax | 0.1897E−04 |
| 0.3 Hmax | 0.7022E−04 |
| 0.4 Hmax | 0.1900E−03 |
| 0.5 Hmax | 0.4395E−03 |
| 0.6 Hmax | 0.9265E−03 |
| 0.7 Hmax | 0.1830E−02 |
| 0.8 Hmax | 0.3428E−02 |
| 0.9 Hmax | 0.6120E−02 |
| 1.0 Hmax | 0.1044E−01 |
| r18 | |
| 0.1 Hmax | −0.2409E−06 |
| 0.2 Hmax | −0.1935E−05 |
| 0.3 Hmax | −0.6567E−05 |
| 0.4 Hmax | −0.1564E−04 |
| 0.5 Hmax | −0.3061E−04 |
| 0.6 Hmax | −0.5263E−04 |
| 0.7 Hmax | −0.8235E−04 |
| 0.8 Hmax | −0.1197E−03 |
| 0.9 Hmax | −0.1645E−03 |
| 1.0 Hmax | −0.2188E−03 |
| r19 | |
| 0.1 Hmax | 0.2249E−06 |
| 0.2 Hmax | 0.1798E−05 |
| 0.3 Hmax | 0.6062E−05 |
| 0.4 Hmax | 0.1435E−04 |
| 0.5 Hmax | 0.2800E−04 |
| 0.6 Hmax | 0.4842E−04 |
| 0.7 Hmax | 0.7715E−04 |
| 0.8 Hmax | 0.1161E−03 |
| 0.9 Hmax | 0.1681E−03 |
| 1.0 Hmax | 0.2372E−03 |

[Embodiment 2]

| | | |
|---|---|---|
| (1) | f1/f1W: | 7.50 |
| (2) | f2/f1W: | −1.10 |
| (3) | f3/f1W: | 1.27 |
| (4) | img * R: | 7.8 |
| (5) | Ra/f3: | 0.59 |
| (6) | R2n/f2: | −0.73 |
| (6)′ | f2p/f2: | — |
| (7) | νn: | 29.85 |
| (8) | νp: | 52.69 |
| (9) | m1/Z: | 1.69 |
| (10) | M1WM/M1MT: | 1.33 |
| (11) | max(T1,T2,T3)/f1W: | 2.19 |
| (12) | Lw/f1W: | 7.80 |
| (13) | Δβ3/Δβ2: | 0.479 |
| (14) | βT2/βw2: | 4.45 |
| (15) | fT/\|f12W\|: | 6.05 |
| (16) | φ * (N′ − N) * d/dH{X(H) − X0(H)} | |

| | |
|---|---|
| r11 | |
| 0.1 Hmax | 0.2295E−05 |
| 0.2 Hmax | 0.1801E−04 |
| 0.3 Hmax | 0.5851E−04 |
| 0.4 Hmax | 0.1298E−03 |
| 0.5 Hmax | 0.2285E−03 |
| 0.6 Hmax | 0.3386E−03 |
| 0.7 Hmax | 0.4304E−03 |
| 0.8 Hmax | 0.4548E−03 |
| 0.9 Hmax | 0.3054E−03 |
| 1.0 Hmax | −0.3160E−03 |
| r13 | |
| 0.1 Hmax | −0.2424E−04 |
| 0.2 Hmax | −0.1929E−03 |
| 0.3 Hmax | −0.6441E−03 |
| 0.4 Hmax | −0.1498E−02 |
| 0.5 Hmax | −0.2841E−02 |
| 0.6 Hmax | −0.4713E−02 |
| 0.7 Hmax | −0.7112E−02 |
| 0.8 Hmax | −0.1000E−01 |
| 0.9 Hmax | −0.1329E−01 |
| 1.0 Hmax | −0.1657E−01 |

| | |
|---|---|
| (17) | φ * (N′ − N) * d/dH{X(H) − X0(H)} |

| | |
|---|---|
| r15 | |
| 0.1 Hmax | −0.8171E−05 |
| 0.2 Hmax | −0.6760E−04 |
| 0.3 Hmax | −0.2402E−03 |
| 0.4 Hmax | −0.6071E−03 |
| 0.5 Hmax | −0.1276E−02 |
| 0.6 Hmax | −0.2397E−02 |
| 0.7 Hmax | −0.4202E−02 |
| 0.8 Hmax | −0.7142E−02 |
| 0.9 Hmax | −0.1222E−01 |
| 1.0 Hmax | −0.2174E−01 |
| r21 | |
| 0.1 Hmax | 0.7678E−06 |
| 0.2 Hmax | 0.6178E−05 |
| 0.3 Hmax | 0.2110E−04 |
| 0.4 Hmax | 0.5108E−04 |
| 0.5 Hmax | 0.1031E−03 |
| 0.6 Hmax | 0.1871E−03 |
| 0.7 Hmax | 0.3174E−03 |
| 0.8 Hmax | 0.5169E−03 |
| 0.9 Hmax | 0.8243E−03 |
| 1.0 Hmax | 0.1311E−02 |
| r22 | |
| 0.1 Hmax | −0.6757E−05 |
| 0.2 Hmax | −0.5453E−04 |
| 0.3 Hmax | −0.1858E−03 |
| 0.4 Hmax | −0.4430E−03 |
| 0.5 Hmax | −0.8648E−03 |
| 0.6 Hmax | −0.1486E−02 |
| 0.7 Hmax | −0.2345E−02 |
| 0.8 Hmax | −0.3487E−02 |
| 0.9 Hmax | −0.4902E−02 |
| 1.0 Hmax | −0.6245E−02 |

Embodiment 3]

| | | |
|---|---|---|
| (1) | f1/f1W: | 7.50 |
| (2) | f2/f1W: | −1.08 |
| (3) | f3/f1W: | 1.29 |
| (4) | img * R: | 7.8 |
| (5) | Ra/f3: | 0.58 |
| (6) | R2n/f2: | −0.72 |
| (6)′ | f2p/f2: | −1.72 |
| (7) | νn: | 27.49 |
| (8) | νp: | 61.49 |
| (9) | m1/Z: | 1.64 |
| (10) | M1WM/M1MT: | 1.99 |
| (11) | max(T1,T2,T3)/f1W: | 2.15 |
| (12) | Lw/f1W: | 7.80 |
| (13) | Δβ3/Δβ2: | 0.276 |
| (14) | βT2/βw2: | 5.87 |
| (15) | fT/\|f12W\|: | 6.30 |
| (16) | φ * (N′ − N) * d/dH{X(H) − X0(H)} | |

| | |
|---|---|
| r11 | |
| 0.1 Hmax | 0.4444E−05 |
| 0.2 Hmax | 0.3516E−04 |
| 0.3 Hmax | 0.1157E−03 |
| 0.4 Hmax | 0.2617E−03 |
| 0.5 Hmax | 0.4735E−03 |
| 0.6 Hmax | 0.7325E−03 |
| 0.7 Hmax | 0.1005E−02 |
| 0.8 Hmax | 0.1248E−02 |
| 0.9 Hmax | 0.1387E−02 |
| 1.0 Hmax | 0.1160E−02 |
| r13 | |
| 0.1 Hmax | −0.2158E−04 |
| 0.2 Hmax | −0.1719E−03 |
| 0.3 Hmax | −0.5752E−03 |
| 0.4 Hmax | −0.1343E−02 |
| 0.5 Hmax | −0.2562E−02 |
| 0.6 Hmax | −0.4292E−02 |
| 0.7 Hmax | −0.6580E−02 |
| 0.8 Hmax | −0.9480E−02 |
| 0.9 Hmax | −0.1306E−01 |
| 1.0 Hmax | −0.1722E−01 |

| | |
|---|---|
| (17) | φ * (N′ − N) * d/dH{X(H) − X0(H)} |

| | |
|---|---|
| r15 | |
| 0.1 Hmax | −0.8057E−05 |
| 0.2 Hmax | −0.6645E−04 |
| 0.3 Hmax | −0.2351E−03 |
| 0.4 Hmax | −0.5916E−03 |
| 0.5 Hmax | −0.1238E−02 |
| 0.6 Hmax | −0.2316E−02 |
| 0.7 Hmax | −0.4041E−02 |
| 0.8 Hmax | −0.6824E−02 |
| 0.9 Hmax | −0.1156E−01 |
| 1.0 Hmax | −0.2027E−01 |
| r21 | |
| 0.1 Hmax | 0.1954E−05 |
| 0.2 Hmax | 0.1575E−04 |
| 0.3 Hmax | 0.5397E−04 |
| 0.4 Hmax | 0.1312E−03 |
| 0.5 Hmax | 0.2662E−03 |
| 0.6 Hmax | 0.4849E−03 |
| 0.7 Hmax | 0.8255E−03 |
| 0.8 Hmax | 0.1346E−02 |
| 0.9 Hmax | 0.2142E−02 |
| 1.0 Hmax | 0.3882E−02 |
| r22 | |
| 0.1 Hmax | −0.5091E−05 |
| 0.2 Hmax | −0.4136E−04 |
| 0.3 Hmax | −0.1423E−03 |
| 0.4 Hmax | −0.3433E−03 |
| 0.5 Hmax | −0.6782E−03 |
| 0.6 Hmax | −0.1180E−02 |
| 0.7 Hmax | −0.1882E−02 |
| 0.8 Hmax | −0.2822E−02 |
| 0.9 Hmax | −0.3966E−02 |
| 1.0 Hmax | −0.4941E−02 |

[Embodiment 4]

| | | |
|---|---|---|
| (1) | f1/f1W: | 7.50 |
| (2) | f2/f1W: | −0.77 |
| (3) | f3/f1W: | 1.56 |
| (4) | img * R: | 9.0 |
| (5) | Ra/f3: | 0.67 |
| (6) | R2n/f2: | −0.83 |
| (6)′ | f2p/f2: | — |
| (7) | νn: | 23.23 |
| (8) | νp: | 56.38 |
| (9) | m1/Z: | 0.77 |
| (10) | M1WM/M1MT: | 1.89 |
| (11) | max(T1,T2,T3)/f1W: | 2.76 |
| (12) | Lw/f1w: | 7.80 |
| (13) | Δβ3/Δβ2: | 0.519 |
| (14) | βT2/βw2: | 4.29 |
| (15) | fT/\|f12W\|: | 7.56 |
| (16) | φ * (N′ − N) * d/dH{X(H) − X0(H)} | |

| | |
|---|---|
| r6 | |
| 0.1 Hmax | 0.4744E−05 |
| 0.2 Hmax | 0.3648E−04 |
| 0.3 Hmax | 0.1159E−03 |
| 0.4 Hmax | 0.2559E−03 |
| 0.5 Hmax | 0.4680E−03 |
| 0.6 Hmax | 0.7769E−03 |
| 0.7 Hmax | 0.1241E−02 |
| 0.8 Hmax | 0.1973E−02 |
| 0.9 Hmax | 0.3146E−02 |
| 1.0 Hmax | 0.4992E−02 |
| r7 | |
| 0.1 Hmax | 0.7598E−05 |
| 0.2 Hmax | 0.5904E−04 |
| 0.3 Hmax | 0.1937E−03 |
| 0.4 Hmax | 0.4552E−03 |
| 0.5 Hmax | 0.9051E−03 |
| 0.6 Hmax | 0.1632E−02 |
| 0.7 Hmax | 0.2839E−02 |
| 0.8 Hmax | 0.5410E−02 |
| 0.9 Hmax | 0.1304E−01 |
| 1.0 Hmax | 0.3824E−01 |

| | |
|---|---|
| (17) | φ * (N′ − N) * d/dH{X(H) − X0(H)} |

| | |
|---|---|
| r14 | |
| 0.1 Hmax | 0.4440E−06 |
| 0.2 Hmax | 0.3521E−05 |
| 0.3 Hmax | 0.1170E−04 |
| 0.4 Hmax | 0.2711E−04 |
| 0.5 Hmax | 0.5127E−04 |
| 0.6 Hmax | 0.8491E−04 |
| 0.7 Hmax | 0.1279E−03 |
| 0.8 Hmax | 0.1796E−03 |
| 0.9 Hmax | 0.2412E−03 |
| 1.0 Hmax | 0.3202E−03 |
| r15 | |
| 0.1 Hmax | 0.1798E−05 |
| 0.2 Hmax | 0.1558E−04 |
| 0.3 Hmax | 0.5975E−04 |
| 0.4 Hmax | 0.1678E−03 |
| 0.5 Hmax | 0.4013E−03 |
| 0.6 Hmax | 0.8676E−03 |
| 0.7 Hmax | 0.1740E−02 |
| 0.8 Hmax | 0.3263E−02 |
| 0.9 Hmax | 0.5719E−02 |
| 1.0 Hmax | 0.9272E−02 |
| r18 | |
| 0.1 Hmax | 0.9843E−08 |
| 0.2 Hmax | 0.7949E−07 |
| 0.3 Hmax | 0.2721E−06 |
| 0.4 Hmax | 0.6562E−06 |
| 0.5 Hmax | 0.1305E−05 |
| 0.6 Hmax | 0.2297E−05 |
| 0.7 Hmax | 0.3737E−05 |
| 0.8 Hmax | 0.5826E−05 |
| 0.9 Hmax | 0.9094E−05 |
| 1.0 Hmax | 0.1493E−04 |
| r19 | |
| 0.1 Hmax | −0.4833E−06 |
| 0.2 Hmax | −0.3850E−05 |
| 0.3 Hmax | −0.1290E−04 |
| 0.4 Hmax | −0.3032E−04 |
| 0.5 Hmax | −0.5870E−04 |
| 0.6 Hmax | −0.1008E−03 |
| 0.7 Hmax | −0.1604E−03 |
| 0.8 Hmax | −0.2436E−03 |
| 0.9 Hmax | −0.3623E−03 |
| 1.0 Hmax | −0.5391E−03 |

[Embodiment 5]

| | | |
|---|---|---|
| (1) | f1/f1W: | 8.48 |
| (2) | f2/f1W: | −1.07 |
| (3) | f3/f1W: | 1.55 |
| (4) | img * R: | 7.86 |
| (5) | Ra/f3: | 0.80 |
| (6) | R2n/f2: | −1.03 |
| (6)′ | f2p/f2: | −1.92 |
| (7) | νn: | 25.00 |
| (8) | νp: | 70.44, 61.66 |
| (9) | m1/Z: | 2.46 |
| (10) | M1WM/M1MT: | 0.98 |
| (11) | max(T1,T2,T3)/f1W: | 1.68 |
| (12) | Lw/f1W: | 7.80 |
| (13) | Δβ3/Δβ2: | 0.790 |
| (14) | βT2/βw2: | 3.47 |
| (15) | fT/\|f12W\|: | 6.66 |
| (16) | φ * (N′ − N) * d/dH{X(H) − X0(H)} | |

| | |
|---|---|
| r11 | |
| 0.1 Hmax | 0.1206E−04 |
| 0.2 Hmax | 0.9798E−04 |
| 0.3 Hmax | 0.3307E−03 |
| 0.4 Hmax | 0.7526E−03 |
| 0.5 Hmax | 0.1327E−02 |
| 0.6 Hmax | 0.1931E−02 |
| 0.7 Hmax | 0.2446E−02 |
| 0.8 Hmax | 0.2890E−02 |
| 0.9 Hmax | 0.3121E−02 |
| 1.0 Hmax | 0.9253E−03 |
| r13 | |
| 0.1 Hmax | −0.6375E−05 |
| 0.2 Hmax | −0.5121E−04 |
| 0.3 Hmax | −0.1730E−03 |
| 0.4 Hmax | −0.4062E−03 |
| 0.5 Hmax | −0.7737E−03 |
| 0.6 Hmax | −0.1280E−02 |
| 0.7 Hmax | −0.1917E−02 |
| 0.8 Hmax | −0.2672E−02 |
| 0.9 Hmax | −0.3528E−02 |
| 1.0 Hmax | −0.4352E−02 |

| | |
|---|---|
| (17) | φ * (N′ − N) * d/dH{X(H) − X0(H)} |

| | |
|---|---|
| r22 | |
| 0.1 Hmax | 0.1382E−04 |
| 0.2 Hmax | 0.1107E−03 |
| 0.3 Hmax | 0.3761E−03 |
| 0.4 Hmax | 0.9042E−03 |
| 0.5 Hmax | 0.1810E−02 |
| 0.6 Hmax | 0.3244E−02 |
| 0.7 Hmax | 0.5408E−02 |
| 0.8 Hmax | 0.8589E−02 |
| 0.9 Hmax | 0.1329E−01 |
| 1.0 Hmax | 0.2059E−01 |

[Embodiment 6]

| | | |
|---|---|---|
| (1) | f1/f1W: | 7.96 |
| (2) | f2/f1W: | −1.07 |
| (3) | f3/f1W: | 1.47 |
| (4) | img * R: | 8.77 |
| (5) | Ra/f3: | 1.07 |
| (6) | R2n/f2: | −1.01 |
| (6)′ | f2p/f2: | — |
| (7) | νn: | 22.60 |
| (8) | νp: | 42.83, 51.57 |
| (9) | m1/Z: | 2.11 |
| (10) | M1WM/M1MT: | 1.32 |
| (11) | max(T1,T2,T3)/f1W: | 2.15 |
| (12) | Lw/f1W: | 7.96 |
| (13) | Δβ3/Δβ2: | 0.870 |
| (14) | βT2/βw2: | 3.31 |
| (15) | fT/\|f12W\|: | 6.33 |
| (16) | φ * (N′ − N) * d/dH{X(H) − X0(H)} | |

| | |
|---|---|
| r8 | |
| 0.1 Hmax | 0.3517E−06 |
| 0.2 Hmax | 0.4295E−05 |
| 0.3 Hmax | 0.1921E−04 |
| 0.4 Hmax | 0.4923E−04 |
| 0.5 Hmax | 0.8826E−04 |
| 0.6 Hmax | 0.1401E−03 |
| 0.7 Hmax | 0.2507E−03 |
| 0.8 Hmax | 0.3569E−03 |
| 0.9 Hmax | −0.6708E−03 |
| 1.0 Hmax | −0.8220E−02 |
| r14 | |
| 0.1 Hmax | −0.2459E−06 |
| 0.2 Hmax | −0.1948E−05 |
| 0.3 Hmax | −0.6476E−05 |
| 0.4 Hmax | −0.1508E−04 |
| 0.5 Hmax | −0.2892E−04 |
| 0.6 Hmax | −0.4910E−04 |
| 0.7 Hmax | −0.7656E−04 |
| 0.8 Hmax | −0.1115E−03 |
| 0.9 Hmax | −0.1517E−03 |
| 1.0 Hmax | −0.1895E−03 |

| | |
|---|---|
| (17) | φ * (N′ − N) * d/dH{X(H) − X0(H)} |

| | |
|---|---|
| r16 | |
| 0.1 Hmax | −0.5975E−05 |
| 0.2 Hmax | −0.4791E−04 |
| 0.3 Hmax | −0.1625E−03 |
| 0.4 Hmax | −0.3888E−03 |
| 0.5 Hmax | −0.7699E−03 |
| 0.6 Hmax | −0.1354E−02 |
| 0.7 Hmax | −0.2196E−02 |
| 0.8 Hmax | −0.3359E−02 |
| 0.9 Hmax | −0.4945E−02 |
| 1.0 Hmax | −0.7194E−02 |
| r23 | |
| 0.1 Hmax | 0.1179E−05 |
| 0.2 Hmax | 0.9551E−05 |
| 0.3 Hmax | 0.3271E−04 |
| 0.4 Hmax | 0.7834E−04 |
| 0.5 Hmax | 0.1535E−03 |
| 0.6 Hmax | 0.2646E−03 |
| 0.7 Hmax | 0.4201E−03 |
| 0.8 Hmax | 0.6324E−03 |
| 0.9 Hmax | 0.9092E−03 |
| 1.0 Hmax | 0.1202E−02 |

[Embodiment 7]

| | | |
|---|---|---|
| (1) | f1/f1W: | 5.39 |
| (2) | f2/f1W: | −0.92 |
| (3) | f3/f1W: | 1.56 |
| (4) | img * R: | 8.65 |
| (5) | Ra/f3: | 0.60 |
| (6) | R2n/f2: | −1.28 |
| (6)′ | f2p/f2: | — |
| (7) | νn: | 23.23 |
| (8) | νp: | 56.38, 51.57 |
| (9) | m1/Z: | 1.01 |
| (10) | M1WM/M1MT: | 2.19 |
| (11) | max(T1,T2,T3)/f1W: | 2.15 |
| (12) | Lw/f1W: | 7.84 |
| (13) | Δβ3/Δβ2: | 0.33 |
| (14) | βT2/βw2: | 5.38 |
| (15) | fT/\|f12W\|: | 6.96 |
| (16) | φ * (N′ − N) * d/dH{X(H) − X0(H)} | |

| | |
|---|---|
| r6 | |
| 0.1 Hmax | 0.1113E−04 |
| 0.2 Hmax | 0.8527E−04 |
| 0.3 Hmax | 0.2690E−03 |
| 0.4 Hmax | 0.5852E−03 |
| 0.5 Hmax | 0.1038E−02 |
| 0.6 Hmax | 0.1624E−02 |
| 0.7 Hmax | 0.2347E−02 |
| 0.8 Hmax | 0.3241E−02 |
| 0.9 Hmax | 0.4473E−02 |
| 1.0 Hmax | 0.6691E−02 |
| r7 | |
| 0.1 Hmax | 0.2017E−04 |
| 0.2 Hmax | 0.1590E−03 |
| 0.3 Hmax | 0.5252E−03 |
| 0.4 Hmax | 0.1214E−02 |
| 0.5 Hmax | 0.2307E−02 |
| 0.6 Hmax | 0.3872E−02 |
| 0.7 Hmax | 0.5938E−02 |
| 0.8 Hmax | 0.8459E−02 |
| 0.9 Hmax | 0.1134E−01 |
| 1.0 Hmax | 0.1472E−01 |

| | |
|---|---|
| (17) | φ * (N′ − N) * d/dH{X(H) − X0(H)} |

| | |
|---|---|
| r12 | |
| 0.1 Hmax | −0.8522E−05 |
| 0.2 Hmax | −0.6876E−04 |
| 0.3 Hmax | −0.2358E−03 |
| 0.4 Hmax | −0.5737E−02 |
| 0.5 Hmax | −0.1164E−02 |
| 0.6 Hmax | −0.2120E−02 |
| 0.7 Hmax | −0.3599E−02 |
| 0.8 Hmax | −0.5820E−02 |
| 0.9 Hmax | −0.9017E−02 |
| 1.0 Hmax | −0.1369E−01 |
| r19 | |
| 0.1 Hmax | −0.3652E−05 |
| 0.2 Hmax | −0.2909E−04 |
| 0.3 Hmax | −0.9732E−04 |
| 0.4 Hmax | −0.2273E−03 |
| 0.5 Hmax | −0.4326E−03 |
| 0.6 Hmax | −0.7148E−03 |
| 0.7 Hmax | −0.1047E−02 |
| 0.8 Hmax | −0.1347E−02 |
| 0.9 Hmax | −0.1419E−02 |
| 1.0 Hmax | −0.8695E−03 |

[Embodiment 8]

| | | |
|---|---|---|
| (1) | f1/f1W: | 6.53 |
| (2) | f2/f1W: | −1.25 |
| (3) | f3/f1W: | 1.82 |
| (4) | img * R: | 7.07 |
| (5) | Ra/f3: | 0.72 |
| (6) | R2n/f2: | −0.83 |
| (6)′ | f2p/f2: | — |
| (7) | νn: | 21.00 |
| (8) | νp: | 70.44, 61.66 |
| (9) | m1/Z: | 0.76 |
| (10) | M1WM/M1MT: | 1.94 |
| (11) | max(T1,T2,T3)/f1W: | 1.24 |
| (12) | Lw/f1W: | 9.25 |
| (13) | Δβ3/Δβ2: | 0.57 |
| (14) | βT2/βw2: | 4.12 |
| (15) | fT/\|f12W\|: | −5.06 |
| (16) | φ * (N′ − N) * d/dH{X(H) − X0(H)} | |

| | |
|---|---|
| r11 | |
| 0.1 Hmax | −0.5397E−05 |
| 0.2 Hmax | −0.3734E−04 |
| 0.3 Hmax | −0.9832E−04 |
| 0.4 Hmax | −0.1665E−03 |
| 0.5 Hmax | −0.2431E−03 |
| 0.6 Hmax | −0.4716E−03 |
| 0.7 Hmax | −0.1351E−02 |
| 0.8 Hmax | −0.4072E−02 |
| 0.9 Hmax | −0.1099E−01 |
| 1.0 Hmax | −0.2626E−01 |
| r12 | |
| 0.1 Hmax | −0.1817E−06 |
| 0.2 Hmax | −0.1062E−05 |
| 0.3 Hmax | −0.1601E−05 |
| 0.4 Hmax | 0.1705E−05 |
| 0.5 Hmax | 0.1351E−04 |
| 0.6 Hmax | 0.3528E−04 |
| 0.7 Hmax | 0.5683E−04 |
| 0.8 Hmax | 0.4287E−04 |
| 0.9 Hmax | −0.8661E−04 |
| 1.0 Hmax | −0.4831E−03 |

| | |
|---|---|
| (17) | φ * (N′ − N) * d/dH{X(H) − X0(H)} |

| | |
|---|---|
| r18 | |
| 0.1 Hmax | −0.3199E−04 |
| 0.2 Hmax | −0.2519E−03 |
| 0.3 Hmax | −0.8291E−03 |
| 0.4 Hmax | −0.1903E−02 |
| 0.5 Hmax | −0.3584E−02 |
| 0.6 Hmax | −0.5972E−02 |
| 0.7 Hmax | −0.9181E−02 |
| 0.8 Hmax | −0.1337E−01 |
| 0.9 Hmax | −0.1876E−01 |
| 1.0 Hmax | −0.2560E−01 |
| r19 | |
| 0.1 Hmax | −0.2764E−04 |
| 0.2 Hmax | −0.2166E−03 |
| 0.3 Hmax | −0.7063E−03 |
| 0.4 Hmax | −0.1597E−02 |
| 0.5 Hmax | −0.2939E−02 |
| 0.6 Hmax | −0.4737E−02 |
| 0.7 Hmax | −0.6968E−02 |
| 0.8 Hmax | −0.9612E−02 |
| 0.9 Hmax | −0.1270E−01 |
| 1.0 Hmax | −0.1640E−01 |

[Embodiment 9]

| | | |
|---|---|---|
| (1) | f1/f1W: | 4.80 |
| (2) | f2/f1W: | −0.76 |
| (3) | f3/f1W: | 1.55 |
| (4) | img * R: | 9.95 |
| (5) | Ra/f3: | 0.81 |
| (6) | R2n/f2: | −0.84 |
| (6)′ | f2p/f2: | −2.68 |
| (7) | νn: | 24.6 |
| (8) | νp: | 59.25, 59.03 |
| (9) | m1/Z: | 1.45 |
| (10) | M1WM/M1MT: | 0.90 |
| (11) | max(T1,T2,T3)/f1W: | 1.43 |
| (12) | Lw/f1W: | 7.81 |
| (13) | Δβ3/Δβ2: | 0.78 |
| (14) | βT2/βw2: | 3.50 |
| (15) | fT/\|f12W\|: | 7.86 |
| (16) | φ * (N′ − N) * d/dH{X(H) − X0(H)} | |

| | |
|---|---|
| r11 | |
| 0.1 Hmax | 0.2295E−05 |
| 0.2 Hmax | 0.1801E−04 |
| 0.3 Hmax | 0.5851E−04 |
| 0.4 Hmax | 0.1298E−03 |
| 0.5 Hmax | 0.2285E−03 |
| 0.6 Hmax | 0.3386E−03 |
| 0.7 Hmax | 0.4304E−03 |
| 0.8 Hmax | 0.4548E−03 |
| 0.9 Hmax | 0.3054E−03 |
| 1.0 Hmax | 0.3160E−03 |

| | |
|---|---|
| (17) | φ * (N′ − N) * d/dH{X(H) − X0(H)} |

| | |
|---|---|
| r13 | |
| 0.1 Hmax | −0.2424E−04 |
| 0.2 Hmax | −0.1929E−03 |
| 0.3 Hmax | −0.6441E−03 |
| 0.4 Hmax | −0.1498E−02 |
| 0.5 Hmax | −0.2841E−02 |
| 0.6 Hmax | −0.4713E−02 |
| 0.7 Hmax | −0.7112E−02 |
| 0.8 Hmax | −0.1000E−01 |
| 0.9 Hmax | −0.1329E−01 |
| 1.0 Hmax | −0.1657E−01 |
| r15 | |
| 0.1 Hmax | −0.8171E−05 |
| 0.2 Hmax | −0.6760E−04 |
| 0.3 Hmax | −0.2402E−03 |
| 0.4 Hmax | −0.6071E−03 |
| 0.5 Hmax | −0.1276E−02 |
| 0.6 Hmax | −0.2397E−02 |
| 0.7 Hmax | −0.4202E−02 |
| 0.8 Hmax | −0.7142E−02 |
| 0.9 Hmax | −0.1222E−01 |
| 1.0 Hmax | −0.2174E−01 |
| r21 | |
| 0.1 Hmax | 0.7678E−04 |
| 0.2 Hmax | 0.6178E−03 |
| 0.3 Hmax | 0.2110E−03 |
| 0.4 Hmax | 0.5108E−02 |
| 0.5 Hmax | 0.1031E−02 |
| 0.6 Hmax | 0.1871E−02 |
| 0.7 Hmax | 0.3174E−02 |
| 0.8 Hmax | 0.5169E−02 |
| 0.9 Hmax | 0.8243E−01 |
| 1.0 Hmax | 0.1311E−01 |
| r22 | |
| 0.1 Hmax | −0.6757E−05 |
| 0.2 Hmax | −0.5453E−04 |
| 0.3 Hmax | −0.1858E−03 |
| 0.4 Hmax | −0.4430E−03 |
| 0.5 Hmax | −0.8648E−03 |
| 0.6 Hmax | −0.1486E−02 |
| 0.7 Hmax | −0.2345E−02 |
| 0.8 Hmax | −0.3487E−02 |
| 0.9 Hmax | −0.4902E−02 |
| 1.0 Hmax | −0.6245E−02 |

As described above in detail, according to the invention, it is possible to provide a zoom lens system which is compact although the system can satisfy requirements of a high variable magnification and a high image quality.

Therefore, when the zoom lens system of the invention is applied to an imaging optical system of a digital camera, the zoom lens system can contribute to a high performance and compactness of the camera.

Reasonable variations and modifications of the invention are possible within the scope of the foregoing description, the drawings and the appended claims to the invention.

1. A zoom lens system comprising, from an object side of the zoom lens system to an image side of the zoom lens system:
a first lens unit having a positive optical power, the first lens unit being movable in a zooming operation:
a second lens unit having a negative optical power; and
a third lens unit having a positive optical power;
wherein a zooming operation is performed by varying distances between adjacent ones of the first, second, and third lens units; and
wherein the zoom lens system satisfies the following condition:
0.8<M1WM/M1MT<2.5
where
M1WM represents a movement amount of the first lens unit from a shortest focal length condition to a middle focal length condition; and
M1MT represents a movement amount of the first lens unit from the middle focal length condition to a longest focal length condition, the middle focal length being a focal length which is (fW/fT)^{1/2} where fW is a focal length of the entire zoom lens system at the shortest focal length condition and fT is a focal length of the entire zoom lens system at the longest focal length condition.

2. A zoom lens system as claimed in claim 1, wherein the first and third lens unit are movable in a zooming operation so that a first distance between the first and second lens units increases and a second distance between the second and third lens units decreases.

3. A zoom lens system as claimed in claim 1, wherein the first, second, and third lens units are movable in a zooming operation so that a first distance between the first and second lens units increases and a second distance between the second and third lens units decreases.

4. A zoom lens system comprising, from an object side of the zoom lens system to an image side of the zoom lens system:
a first lens unit having a positive optical power, the first lens unit being movable in a zooming operation;
a second lens unit having a negative optical power; and
a third lens unit having a positive optical power;
wherein a zooming operation is performed by varying distances between adjacent ones of the first, second, and third lens units; and
wherein the zoom lens system satisfies the following condition:
0.2<Δβ3/Δβ2<1.0
where
Δβ2 represents a ratio of a lateral magnification (lateral magnification at a longest focal length condition/lateral magnification at a shortest focal length condition) of the second lens unit; and
Δβ3 represents a ratio of a lateral magnification (lateral magnification at the longest focal length condition/lateral magnification at the shortest focal length condition) of the third lens unit.

5. A zoom lens system as claimed in claim 4, wherein the first and third lens units are movable in a zooming operation so that a first distance between the first and second lens units increases and a second distance between the second and third lens units decreases.

6. A zoom lens system as claimed in claim 4, wherein the first, second, and third lens unit are movable in a zooming operation so that a first distance between the first and second lens units increases and a second distance between the second and third lens units decreases.

7. A zoom lens system comprising, from an object side of the zoom lens system to an image side of the zoom lens system:
a first lens unit having a positive optical power, the first lens unit being movable in a zooming operation;
a second lens unit having a negative optical power; and
a third lens unit having a positive optical power;
wherein a zooming operation is performed by varying distances between adjacent ones of the first, second, and third lens units; and
wherein the zoom lens system satisfies the following condition:
0.7<m1/Z<3.0
where
m1 represents a movement amount of the first lens unit in a zooming operation from a shortest focal length condition to a longest focal length condition; and
Z represents a zoom ratio (Z=fT/fW where fW is a focal length of the entire zoom lens system at the shortest focal length condition and fT is a focal length of the entire zoom lens unit at the longest focal length condition).

8. A zoom lens system as claimed in claim 7, wherein the first and third lens units are movable in a zooming operation so that a first distance between the first and second lens units increases and a second distance between the second and third lens units decreases.

9. A zoom lens system as claimed in claim 7, wherein the first, second, and third lens unit are movable in a zooming operation so that a first distance between the first and second lens units increases and a second distance between the second and third lens units decreases.

10. A zoom lens system comprising, from an object side of the zoom lens system to an image side of the zoom lens system:
a first lens unit having a positive optical power, the first lens unit being movable in a zooming operation;
a second lens unit having a negative optical power; and
a third lens unit having a positive optical power;
wherein a zooming operation is performed by varying distances between the first, second, and third lens units; and
wherein the zoom lens system satisfies the following condition:
1.0<img*R<15.0
where
img represents a maximum image height; and
R represents an effective diameter of a lens surface which is closest to the image side among lens surfaces constituting the zoom lens system.

11. A zoom lens system as claimed in claim 10, wherein the first and third lens units are movable in a zooming operation so that a first distance between the first and second lens units increases and a second distance between the second and third lens units decreases.

12. A zoom lens system as claimed in claim 10, wherein the first, second, and third lens unit are movable in the zooming operation so that a first distance between the first and second lens units increases and a second distance between the second and third lens units decreases.

13. A zoom lens system as claimed in claim 10, wherein the third lens unit comprises, in sequence along an optical axis extending from the object side to the image side, a positive lens element having a convex surface on its object side and a negative lens element.

14. A zoom lens system comprising, from an object side of the zoom lens system to an image side of the zoom lens system:
a first lens unit having a positive optical power, the first lens unit being moved in a zooming operation;
a second lens unit having a negative optical power; and
a third lens unit having a positive optical power;
wherein the zooming operation is performed by varying distances between the first, second and third lens units,
wherein the zoom lens system satisfies the following conditions:
1.0<max(T1,T2,T3)/fW<4
4.5<fT/|f12W|<15
where
Ti is an axial thickness of an i-th unit;
max(T1, T2, T3) is a maximum value of thickness;
fT represents a focal length at a longest focal length condition; and
f12W represents a composite focal length of the first and second lens units at a shortest focal length condition.

15. A zoom lens system as claimed in claim 14, wherein the first and third lens units are movable in a zooming operation so that a first distance between the first and second lens units increases and a second distance between the second and third lens units decreases.

16. A zoom lens system as claimed in claim 14, wherein the first, second, and third lens unit are movable in a zooming operation so that a first distance between the first and second lens units increases and a second distance between the second and third lens units decreases.

17. Apparatus comprising:
a solid state imaging device;
filters; and
a zoom lens system for forming an image of an object on said solid state imaging device; wherein said zoom lens system comprises, from an object side of the zoom lens system to an image side of the zoom lens system;
a first lens unit having a positive optical power, the first lens unit being movable in a zooming operation;
a second lens unit having a negative optical power; and
a third lens unit having a positive optical power; and
wherein said filters are provided between the lens units and the solid state imaging device and include an optical low-pass filter and an infrared blocking filter,
wherein a zooming operation is performed by varying distances between the first, second, and third lens units; and
wherein the zoom lens system satisfies the following condition:
0.8<M1WM/M1MT<2.5
where
M1WM represents a movement amount of the first lens unit from a shortest focal length condition to a middle focal length condition; and
M1MT represents a movement amount of the first lens unit from the middle focal length condition to a longest focal length condition, the middle focal length being a focal length which is (fW/fT)^{1/2} where fW is a focal length of the entire zoom lens system at the shortest focal length condition and fT is a focal length of the entire zoom lens unit at the longest focal length condition.

18. Apparatus comprising:
a solid state imaging device;
filters; and
a zoom lens system for forming an image of an object on said solid state imaging device, said zoom lens system comprising, from an object side of the zoom lens system to an image side of said zoom lens system:
a first lens unit having a positive optical power, the first lens unit being movable in a zooming operation:
a second lens unit having a negative optical power; and
a third lens unit having a positive optical power;
wherein said filters are provided between the lens units and the solid state imaging device and include an optical low-pass filter and an infrared blocking filter;
wherein a zooming operation is performed by varying distances between the first, second, and third lens units; and
wherein the zoom lens system satisfies the following condition:
0.2<Δβ3/Δβ2<1.0
where
Δβ2 represents a ratio of a lateral magnification at a longest focal length condition of the second lens unit to a lateral magnification at a shortest focal length condition of the second lens unit; and
Δβ3 represents a ratio of a lateral magnification at a longest focal length condition of the third lens unit to a lateral magnification at a shortest focal length condition of the third lens unit.

19. Apparatus comprising:
a solid state imaging device;
filters; and
a zoom lens system for forming an image of an object on said solid state imaging device, the zoom lens system comprising from an object side of the zoom lens system to an image side of the zoom lens system:
a first lens unit having a positive optical power, the first lens unit being movable in a zooming operation;
a second lens unit having a negative optical power; and
a third lens unit having a positive optical power;
wherein said filters are provided between the lens units and the solid state imaging device and include an optical low-pass filter and an infrared blocking filter;
wherein a zooming operation is performed by varying distances between adjacent ones of the first, second, and third lens units; and
wherein the zoom lens system satisfies the following condition:
0.7<m1/Z<3.0
where
M1 represents a movement amount of the first lens unit in a zooming operation from a shortest focal length condition to a longest focal length condition; and
Z represents a zoom ratio (Z=fT/fW: where fW is a focal length of the entire zoom lens system at the shortest focal length condition and fT is a focal length of the entire zoom lens unit at the longest focal length condition).

20. Apparatus comprising:
a solid state imaging device;
filters; and
a zoom lens system for forming an image of an object on the solid state imaging device, the zoom lens system comprising, from an object side of the zoom lens system to an image side of the zoom lens system:
a first lens unit having a positive optical power, the first lens unit being movable in a zooming operation;
a second lens unit having a negative optical power; and
a third lens unit having a positive optical power;
wherein said filters are provided between the lens units and the solid state imaging device and include an optical low-pass filter and an infrared blocking filter,
wherein a zooming operation is performed by varying distances between adjacent ones of the first, second, and third lens units,
wherein the zoom lens system satisfies the following condition:
1.0<img*R<15.0
where
img represents a maximum image height; and
R represents an effective diameter of a lens surface which is closest to the image side of the zoom lens system among lens surfaces constituting the zoom lens system.
